(19) United States
(12) Patent Application Publication
(10) Pub. No.: US 2024/0377543 A1
(43) Pub. Date: Nov. 14, 2024

(54) METHODS AND SYSTEMS FOR HIGH SPATIOTEMPORAL RADIO-LUMINESCENT IMAGING DOSIMETRY

(71) Applicants: Sreekrishna Goddu, St. Louis, MO (US); Arash Darafsheh, St. Louis, MO (US); Zhen Ji, St. Louis, MO (US)

(72) Inventors: Sreekrishna Goddu, St. Louis, MO (US); Arash Darafsheh, St. Louis, MO (US); Zhen Ji, St. Louis, MO (US)

(73) Assignee: Washington University, St. Louis, MO (US)

(21) Appl. No.: 18/661,385

(22) Filed: May 10, 2024

Related U.S. Application Data
(60) Provisional application No. 63/501,250, filed on May 10, 2023.

(51) Int. Cl. G01T 1/02; G01T 1/20; H04N 23/30

(52) U.S. Cl. CPC G01T 1/023; G01T 1/2002; G01T 1/2018; H04N 23/30

(57) ABSTRACT

The present disclosure provides systems and methods for radio-luminescent imaging dosimetry of variable dose rate radiation beams at high spatial resolution. Exemplary embodiments include time-gating one or more camera shutters such that one image frame from a plastic scintillator detector (PSD) is captured per camera shutter for each radiation beam pulse produced from a pulsed beam accelerator directed toward the PSD.

### CROSS-REFERENCE TO RELATED APPLICATIONS

This application claims priority from U.S. Provisional Application Ser. No. 63/501,250 filed on May 10, 2023, which is incorporated herein by reference in its entirety.

### STATEMENT REGARDING FEDERALLY SPONSORED RESEARCH OR DEVELOPMENT

Not applicable.

### MATERIAL INCORPORATED-BY-REFERENCE

Not applicable.

### FIELD OF THE INVENTION

The present disclosure generally relates to methods and apparatus for imaging dosimetry of variable dose-rate radiation beams.

### BACKGROUND OF THE INVENTION

Proton therapy, thanks to the Bragg peaks (BPs), has dosimetric advantages to better spare organs-at-risk (OARs), especially distal to the target, and deposit a lower integral dose to the surrounding normal tissues in comparison with external beam photon therapy. Due to the major dose deposition in the BP region and sharp distal dose fall-off, considerations associated with proton range uncertainty is of outmost importance in proton therapy. If such uncertainties are not properly addressed, noticeable target under-dose and OAR over-dose may occur, indicating the importance of proton range measurement as a vital part of routine quality assurance (QA).

In pencil beam scanning (PBS) systems, measurement of the position and size of the proton pencil beams is also an integral part of the routine QA. Currently, a few commercial devices exist for rapid measurement of the proton range, size, and location, that include parallel-plate ionization chamber arrays for obtaining depth dose curves, e.g. the Magic Cube or Zebra (IBA dosimetry GmbH, Germany), and scintillation screen of gadolinium-based scintillating material, e.g. Lynx (IBA dosimetry GmbH, Germany), for spot position and size measurements with 0.5 60 mm spatial resolution. However, the spatial resolution of the ionization chamber arrays is limited to several millimeters and neither of the above-mentioned tools can provide measurements on a pulse-by-pulse basis.

Radiation detection and measurements through harnessing radio-luminescent phenomenon is among the oldest techniques in experimental radiation physics and chemistry. Radioluminescence is an umbrella term for physical phenomena, such as fluorescence and phosphorescence, through which visible photons are emitted as a result of radiation-matter interactions. Scintillation usually refers to the “fast”, on the order of a few nanoseconds to microseconds, emission of fluorescent light as opposed to the phosphorescence process. The emitted light can be detected and used for quantitative dosimetry. In the field of radiation oncology clinical physics, scintillation dosimetry has been used for several decades. Recently, scintillation imaging, Cherenkov radiation imaging, and radio-luminescent imaging of un-doped materials have been subject of investigation for potential applications in high spatiotemporal resolution dosimetry. A therapeutic beam can be a pulsed radiation beam, and selected from a proton beam, an electron beam, a photon beam, a carbon ion beam, and any other pulsed ionizing radiation beam.

Existing challenges in scintillation dosimetry of therapeutic beams include Cherenkov radiation and ionization quenching. The former, a critical issue for megavoltage electron and photon beams, is manifested as a “parasitic” signal superimposed on the scintillation signal; it is not a significant problem in proton therapy fields as the produced Cherenkov radiation is several orders of magnitude weaker than the signal from the scintillator. The latter, on the other hand, manifested as an under-response of the scintillator to radiation dose due to non-radiative de-excitation modes, is of concern only in high linear energy transfer (LET) radiation fields. In low LET fields, the light output is directly proportional to the absorbed dose. In practice, ionization quenching can be compensated through semi-empirical or Monte Carlo-derived correction factors.

Radiotherapy at ultra-high dose rate (so called FLASH-RT) has emerged as a potential approach to minimize radiation damage to healthy tissues while maintain the same anti-tumor effectiveness. Due to ultra-high dose rate involved (>40 Gy/s) routinely available dosimeters are not reliable tools for dosimetry of FLASH beams.

### SUMMARY

Among the various aspects of the present disclosure is the provision of a system and method radio-luminescent imaging dosimetry of variable dose rate radiation beams.

Briefly, therefore, the present disclosure is directed to a radio-luminescent imaging system to quantify dose of a radiation beam and methods of use thereof.

The present teachings include systems for computer-implemented scintillation imaging system to quantify a dose of a radiation beam. In one aspect, the system can include a pulsed synchrocyclotron pencil beam source. In another aspect, the system can include a plastic scintillator detector (PSD) facing a high-speed CMOS-camera placed in an optically sealed enclosure. In accordance with another aspect, the system can include another CMOS-camera placed at a 45-degree angle to the scintillator detector. In another aspect, the system can include a retractable mirror able to reflect the beam to, and between, the 2 cameras. In another aspect, the system can include camera shutters synchronized with the beam pulse train. In yet another aspect, the system can include a computer-implemented algorithm to process acquired scintillation images. In other aspects, the computer-implemented process can include correcting background noise, extracting integrated depth-intensity (IDI) curves corrected for ionization-quenching, and quantifying beam range, spot intensity, and spot position in y-direction. In accordance with other aspects, the radiation beam can be selected from a proton beam and a carbon ion beam. In some embodiments, the PSD can be a 5 cm thick BC-408 PSD with a 30×30 cm² cross-sectional area. In some aspects, at least one of the cameras can capture every beam-pulse as an image. In some embodiments, the beam pulse rate is 750 Hz. In other aspects, the widths of the IDI curves at 90%, 80%, and 70% peak height can be evaluated.

The present teachings also include a method to quantify the dose of a radiation beam. In one aspect, the method can include placing a scintillator in the path of a radiation beam, detecting the produced light from the scintillator with a pair of CMOS shuttered cameras synched to the beam pulse train that are switched by inserting and removing a retractable mirror, and processing acquired images with a computer-implemented algorithm. In another aspect, the computer-implemented processing can include correcting background noise, extracting integrated depth-intensity (IDI) curves corrected for ionization-quenching, and quantifying beam range, spot intensity, and spot position in y-direction. In some aspects, the radiation beam can be selected from a proton beam and a carbon ion beam. In other aspects, the PSD can be a 5 cm thick BC-408 PSD with a 30×30 cm² cross-sectional area. In another aspect, at least one of the cameras can capture every beam-pulse as an image. In some embodiments, the beam pulse rate can be 750 Hz. In accordance with another aspect, the widths of the IDI curves at 90%, 80%, and 70% peak height can be evaluated.

In an aspect of the present disclosure, a scintillation imaging system for quantifying a dose of a radiation beam is provided. The system comprises: an accelerator configured to produce a pulsed radiation beam; an optically sealed enclosure comprising a plastic scintillator detector (PSD) and a high-speed camera; and a computing device in communication with the high-speed camera; wherein: the PSD is configured to receive the pulsed radiation beam and to produce a scintillation signal received directly or indirectly at a shutter of the high-speed camera; and the shutter is time-gated such that one scintillation image frame is captured for each radiation beam pulse.

In some embodiments, a shutter speed of the high-speed camera is about equal to a pulse frequency of the accelerator; the accelerator is selected from a synchrocyclotron and a linear accelerator; the pulsed radiation beam is selected from a proton beam, an electron beam, a photon beam, a carbon ion beam, and any other pulsed ionizing radiation beam; and/or the high-speed camera is selected from a complimentary metal-oxide semiconductor (CMOS) camera and a charged-coupled device (CCD). In some embodiments, the computing device comprises a processor configured to execute, for each radiation beam pulse, a computer-implemented algorithm to correct for ionization quenching, to quantify a beam range and to quantify a spot intensity. In some embodiments, the scintillation signal is received indirectly at the shutter of the high-speed camera via a mirror contained within the optically sealed enclosure such that the mirror reflects the scintillation signal from the PSD to the shutter.

In another aspect of the present disclosure, a scintillation imaging system for simultaneous quantifying a dose of a radiation beam is provided. The system comprises: an accelerator configured to produce a pulsed radiation beam; an optically sealed enclosure comprising a plastic scintillator detector (PSD), a mirror, a first high-speed camera, and a second high-speed camera; and a computing device in communication with each of the first and second high-speed cameras; wherein: the PSD is configured to receive the pulsed radiation beam and to produce a scintillation signal; a shutter of the first high-speed camera faces the PSD and receives the scintillation signal directly; a shutter of the second high-speed camera faces the mirror and receives the scintillation signal indirectly as reflected by the mirror; and wherein each shutter is time-gated such that one scintillation image frame is captured by each camera for each radiation beam pulse.

In some embodiments, the mirror is positioned at a 45 degree angle to the pulsed radiation beam; the mirror is retractable; a shutter speed of the first and second high-speed camera is about equal to a pulse frequency of the accelerator; the accelerator is selected from a synchrocyclotron and a linear accelerator; the pulsed radiation beam is selected from a proton beam, an electron beam, a photon beam, a carbon ion beam, and any other pulsed ionizing radiation beam; and/or the high-speed camera is selected from a complimentary metal-oxide semiconductor (CMOS) camera and a charged-coupled device (CCD). In some embodiments, the computing device comprises a processor configured to execute, for each radiation beam pulse, a computer-implemented algorithm to correct for ionization quenching, and to quantify a beam range, a spot intensity, a spot position, and a spot size.

In a further aspect of the present disclosure, a method for quantifying a dose of a radiation beam is provided. The method comprises: directing a pulsed radiation beam toward a plastic scintillation detector (PSD) contained within an optically sealed enclosure, wherein the optically sealed enclosure further comprises a high-speed camera; and time-gating a shutter of the high-speed camera to capture one scintillation image frame for each radiation beam pulse directed toward the PSD.

In some embodiments, the PSD is a first PSD, the directing comprises directing the pulsed radiation beam sequentially toward the first PSD and a second PSD contained within the optically sealed enclosure, and the time-gating comprises time-gating the shutter of the high-speed camera to sequentially capture a first scintillation image frame directly from the first PSD and a second scintillation image frame indirectly from the second PSD as reflected through a mirror contained within the optically sealed enclosure.

In some embodiments, the high-speed camera is a first high-speed camera, and the time-gating comprises time-gating a shutter of the first high-speed camera to capture a first scintillation image frame directly from the PSD and simultaneously time-gating a shutter of a second high-speed camera to capture a second scintillation image indirectly from the PSD as reflected through a mirror contained within the optically sealed enclosure.

In some embodiments, the method further comprises executing a computer-implemented algorithm to correct for ionization quenching and to quantify a beam range, a spot intensity, a spot position, and a spot size for each radiation beam pulse.

Other objects and features will be in part apparent and in part pointed out hereinafter.

### DESCRIPTION OF THE DRAWINGS

The patent or application file contains at least one drawing executed in color. Copies of this patent or patent application publication with color drawing(s) will be provided by the Office upon request and payment of the necessary fee.

Those of skill in the art will understand that the drawings, described below, are for illustrative purposes only. The drawings are not intended to limit the scope of the present teachings in any way.

FIG. 1 is a block diagram schematically illustrating a system in accordance with one aspect of the disclosure.

FIG. 2 is a block diagram schematically illustrating a computing device in accordance with one aspect of the disclosure.

FIG. 3 is a block diagram schematically illustrating a remote or user computing device in accordance with one aspect of the disclosure.

FIG. 4 is a block diagram schematically illustrating a server system in accordance with one aspect of the disclosure.

FIG. 5A is a schematic of the experimental setup of the described systems, composed of a commercial plastic scintillator (BC-400), with 30 cm×30 cm cross-sectional area, facing a high-speed CCD camera housed in an optically sealed enclosure.

The camera's shutter is synchronized to the gantry-mounted synchrocyclotron's beam-pulse-train to capture individual beam pulses.

FIG. 5B is an image of a single pencil beam collected by the high-resolution scintillation camera system.

FIG. 5C is a graph of the integrated depth intensity profiles for different ranges derived by integrating all the horizontal profiles into one, similar to depth dose profiles measured by a parallel-plant ionization chamber.

FIG. 5D is a graph of the profiles before and after correcting for quenching for ranges of 15 cm and 20 cm. Integrated depth intensity profiles were compared against the treatment plan generated integrated depth dose profiles in deriving the quenching correction factors. These factors were used to correct for ionization quenching of integrated depth intensity profiles. Dotted blue lines show that the measured scintillation profiles match the plan profiles.

FIG. 6A is a graph of a pulse-by-pulse analysis of beam range variations for a FLASH beam of 20 cm range.

FIG. 6B is a graph of a pulse-by-pulse analysis of beam spot position variations for a FLASH beam of 20 cm range.

FIG. 6C is a graph of a pulse-by-pulse analysis of average beam spot intensity variations for a FLASH beam of 20 cm range.

FIG. 6D is a graph of a pulse-by-pulse analysis of beam pulse width at 90% peak height variations for a FLASH beam of 20 cm range.

FIG. 6E is a graph of a pulse-by-pulse analysis of beam pulse width at 80% peak height variations for a FLASH beam of 20 cm range.

FIG. 6F is a graph of a pulse-by-pulse analysis of beam pulse width at 70% peak height variations for a FLASH beam of 20 cm range.

FIG. 7A is a schematic showing the camera system's measurement geometry for range, spot intensity, and y-position on a pulse basis.

FIG. 7B is a typical scintillation image of a single spot.

FIG. 7C is a graph of integrated depth dose profiles (IDDs) of different proton beam energies measured by the scintillation camera system.

FIG. 7D is a graph of shifted profiles overlay of different ranges showing the shape of the Bragg-Peaks are similar irrespective of their initial energy.

FIG. 7E is a graph of IDDs before and after quenching corrections applied.

FIG. 7F is a graph of IDDs measured by the camera system compared against Zebra.

FIG. 7G is a graph of range variations measured by the camera system on a pulse-by-pulse basis.

FIG. 7H is a graph of relative spot intensity variations on a pulse-by-pulse basis compared against beam current recorded in machine log files.

FIG. 7I is a graph of variations in beam position in y-direction on a pulse-by-pulse basis.

FIG. 8 is a schematic of an exemplary embodiment of the imaging system of the present disclosure, which includes 2 cameras, a scintillator, and a retractable mirror.

FIG. 9A is a schematic of the measurement setup (not drawn to scale), S1 for range and spot intensity.

FIG. 9B is a schematic of the measurement setup, S2 for spots' positions and size measurements.

FIG. 9C is a picture of the measurement setup closed system showing the light-tight housing, dual layer neutron shield, and the cooling system.

FIG. 9D is a picture of the system wherein the top lid was removed to show S1 (30×30×5 cm³) and S2 (30×30×0.5 cm³) BC-408 plastic scintillator blocks and a mirror that is placed at 45° to reflect the scintillation spots (simultaneous presence of both S1 and S2 is for presentation only. During the measurements, either S1 is present, or S2 and the mirror as shown in the schematics along with their corresponding field-of-view (FoV)).

FIG. 9E is a picture of the CMOS camera connected to a Eurosis frame-grabber (housed in personal computer (PC)) via 4 CXP12 cables and a power/trigger cable.

FIG. 10A is a typical proton beam pulse imaged by the scintillation camera system; typical region selected for integrated depth intensity (IDI) profiles; the vertical lines indicate the locations of the PB width profiles extracted from the images.

FIG. 10B is a graph of a typical IDI profile; same figure shows the locations of the BP widths at 70, 80 and 90% of the peak heights.

FIG. 10C is a graph of a typical profile representing PB widths at a depth of 1 cm.

FIG. 10D is a graph of a typical profile representing PB widths at a depth of mid-range (R/2).

FIG. 10E is a graph of a typical profile representing PB widths at the peak.

FIG. 11A is a schematic of the workflow of the image analysis for range measurements, S1 setup.

FIG. 11B is a schematic of the workflow of the image analysis for spot measurements, S2 setup.

FIG. 12 is a scintillation image and corresponding quantitative graph. Integrated signal was measured at different depths (50 mm, 100 mm, and at the BP) as a function of the delivered monitor units (MUs). Dashed lines are linear fits with corresponding R2 values reported on the plot. Error bars are smaller than the symbol sizes. The MU linearity of the scintillation imaging system indicates that the camera is capable of capturing all of the pulses. The inset shows a typical frame captured when a proton beam with 28 cm range was delivered. The yellow dashed circles (drawn not to scale) indicate the area over which the pixel intensities summed together.

FIG. 13A is a graph of depth intensity profiles of 3 beams with different initial proton energies.

FIG. 13B is a graph of the profiles shown in FIG. 13A that were shifted and overlaid to show that the shape of their distal profile is the same.

FIG. 13C is a graph of scintillation profiles in comparison with the TPS before and after quenching corrections applied.

FIG. 14A is a typical pulse-by-pulse variations of range.

FIG. 14B is a typical pulse-by-pulse variations of normalized spot intensity at peak measurements

FIG. 14C is a typical pulse-by-pulse variations of peak position (y).

FIG. 14D is a typical pulse-by-pulse variations of range BP width at 80% peak height.

FIG. 14E is a typical pulse-by-pulse variations of PB widths at 1 cm depth.

FIG. 14F is a typical pulse-by-pulse variations at peak.

FIG. 15A-D is a set of graphs of measurement results under setup S1. Four off-axis spots are compared against the central axis spot.

FIG. 15A is a graph of the deviation of the measured range from the programmed range.

FIG. 15B is a graph of BP widths at 70%, 80%, and 90% peak height.

FIG. 15C is a graph of pencil beam widths at 1 cm depth, mid-range (R/2), and at the BP.

FIG. 15D is a graph of deviations of relative spots' peak intensities corresponding to 15 spots measured for each range; the deviations from the average spot intensity of all 15 spots in each group.

FIG. 16A-D is a set of measurement results under setup S2 for spots' size and position measurements.

FIG. 16A is an overlaid map of the delivered 49 spots, each consisted of 50 pulses, delivered at different locations four times. Arrows show the scanning direction.

FIG. 16B is a map of the expanded view of the central 9 spots.

FIG. 16C is a graph of measured sigma in x—and y-directions.

FIG. 16D is a graph of deviation of spots' location from their intended x—and y-positions.

### DETAILED DESCRIPTION OF THE INVENTION

The present disclosure is based, at least in part, on the design and development of methods and apparatus for FLASH RT dosimetry at high spatial and temporal resolution. To be specific, at sub-mm spatial resolution and pulse-by-pulse temporal resolution is attained. The device is comprised of two blocks and scintillator media and a mirror enclosed in an optically-tight enclosure, also referred to as a light-tight housing or an optically sealed enclosure. A digital camera (CCD or CMOS) faces one of the scintillators directly and the other indirectly, i.e., through a mirror positioned at an angle (e.g., a 45-degree angle). The switching between scintillators is done sequentially, i.e., the mirror is retracted first and then repositioned for reflection. By gating the camera's shutter to the radiation producing machine (e.g., synchrocyclotron or linear accelerator) and by matching the shutter speed to the pulse frequency, each taken frame will correspond to each radiation macro-pulse. Analysis of digital images will allow us to extract dosimetric characteristics of the beam. For example, range, spot size, intensity, and position for proton therapy beams. This device has potential to save time and money. It has the potential to replace range measurement device such as Zebra and spot verification device such as Lynx.

In some aspects, the present disclosure describes radiotherapy dosimetry at high spatial and temporal resolution. In some aspects, dosimetry of pulsed FLASH radiotherapy beams on a pulse-by-pulse basis with sub millimeter spatial resolution is described. It also provides a robust platform for small field dosimetry. This device is cost effective and save QA time; it can replace range measurement device such as Zebra and spot verification device such as Lynx.

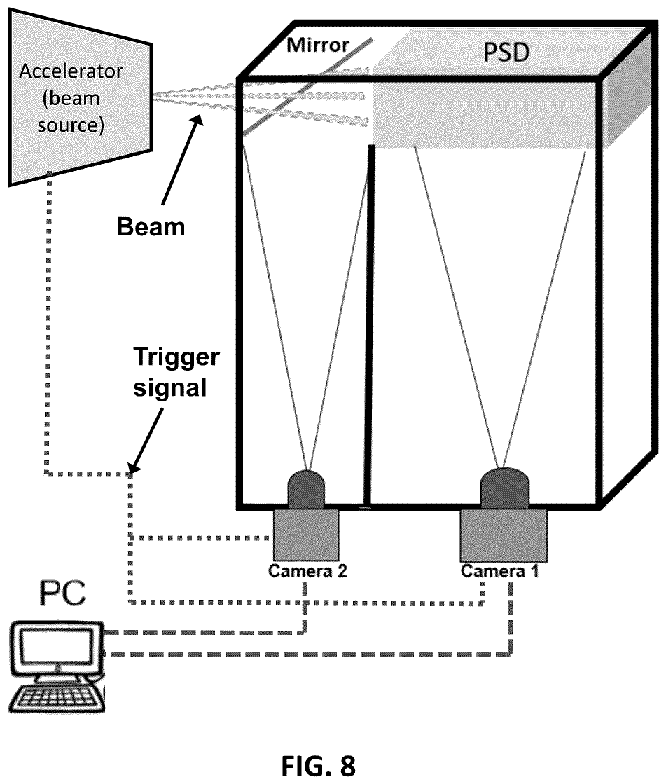

In some aspects, the methodology can be highly efficient for comprehensive QA of proton or carbon ion therapy machines. In some embodiments, the range and spot position & its size can be simultaneously measured. In this embodiment, a single large plastic scintillator is used, but two cameras, one for range and the other for spot measurements, is also used. A third camera (or more) can be used as well, particularly with respect to 3D dosimetry where 3D constructions are produced from multiple 2D images/data sets as described herein. A mirror that is placed at an angle (e.g., a 45-degree angle) in the entrance of the beam reflects the spots onto a 2^{nd} camera for size and sigma measurement. A schematic is shown in FIG. 8. In embodiments, one camera faces a scintillator directly the 2^{nd} camera faces a scintillator indirectly, i.e., through a mirror positioned at an angle (e.g., a 45-degree angle). A scintillation signal received at a camera shutter directly follows a linear, straight, non-deflected, or non-reflected path from the scintillator to the shutter. Emitted light from the scintillator that is either directly or indirectly incident to the shutter is considered to be in optical communication with the shutter. Any light received either directly or indirectly at the shutter is considered to be within the field of view (FoV) of the shutter. Light from a scintillator and reflected by a mirror (or otherwise reflected or deflected with materials generally known in the art to reflect, deflect, and/or change the path of light) is considered to be received at the shutter indirectly from the scintillator (or e.g., considered to be received indirectly with respect to the scintillator). The switching between scintillators is done sequentially, i.e., the mirror is retracted first and then repositioned for reflection.

In some aspects, the system can be used for “conventional” proton therapy quality assurance as well. The advantage over existing devices is its high spatial resolution. In some aspects, time gating is necessary to assure that a whole pulse is recorded and all pulses are recorded (one captured image frame per one delivered pulse). In other embodiments, 3D dosimetry based on reconstruction of dose from two projection images can be performed. Exemplary 3D dosimetry embodiments include at least two or three cameras in a system together with at least one, two, or three scintillators. For example, system embodiments can include: two cameras and one scintillator; two cameras and two scintillators; three cameras and one scintillator; three cameras and two scintillators; and three cameras and three scintillators; and as supported by the configurations and methods disclosed herein.

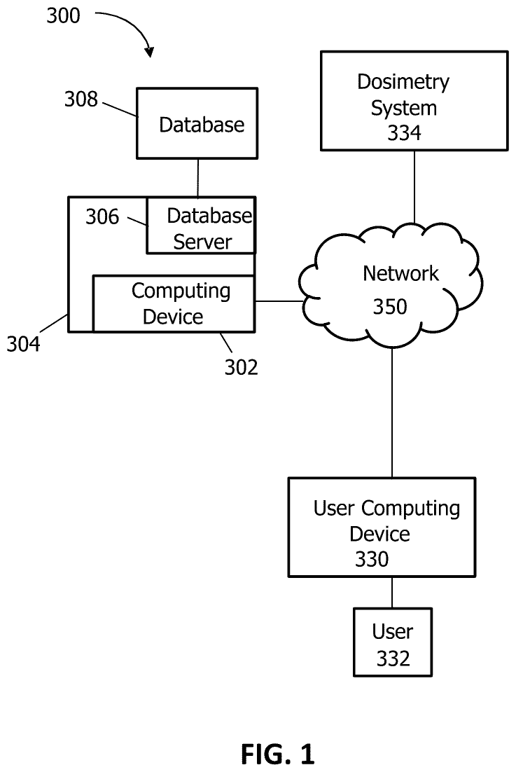

In various aspects, at least a portion of the methods disclosed herein may be implemented using various computing systems and devices as described below. FIG. 1 depicts a simplified block diagram of a computing device for implementing the dosimetry system 334 and methods described herein. As illustrated in FIG. 1, the computing device 300 may be configured to implement at least a portion of the tasks associated with the disclosed dosimetry method, including, but not limited to: producing a calculated radiation beam dose based on medical imaging data of a subject including, but not limited to, FLASH-RT data. The computer system 300 may include a computing device 302. In one aspect, the computing device 302 is part of a server system 304, which also includes a database server 306. The computing device 302 is in communication with a database 308 through the database server 306. The computing device 302 is communicably coupled to a user-computing device 330 through a network 350. The network 350 may be any network that allows local area or wide area communication between the devices. For example, the network 350 may allow communicative coupling to the Internet through at least one of many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. The user-computing device 330 may be any device capable of accessing the Internet including, but not limited to, a desktop computer, a laptop computer, a personal digital assistant (PDA), a cellular phone, a smartphone, a tablet, a phablet, wearable electronics, smartwatch, or other web-based connectable equipment or mobile devices.

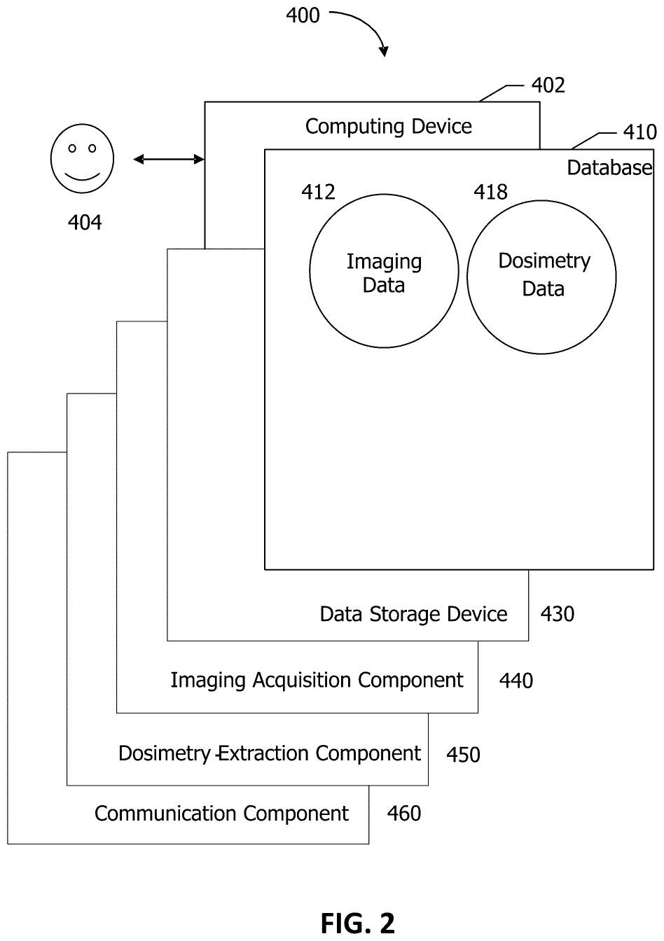

In other aspects, the computing device 302 is configured to perform a plurality of tasks associated with dosimetry in a subject in need using the prenatal screening system as described herein. FIG. 2 depicts a component configuration 400 of computing device 402, which includes database 410 along with other related computing components. In some aspects, computing device 402 is similar to computing device 302 (shown in FIG. 1). A user 404 may access components of computing device 402. In some aspects, database 410 is similar to database 308 (shown in FIG. 1).

In one aspect, database 410 includes imaging data 412 and dosimetry data 418.

Non-limiting examples of dosimetry data 418 include any data characterizing various aspects of imaging data 412 including, but not limited to, FLASH-RT. Non-limiting examples of suitable dosimetry data 418 include any values of parameters defining the dosimetry system, including but not limited to, integrated depth-intensity (IDI) curves (as well as IDI curve widths at 90%, 80%, and 70%) extracted and corrected for ionization-quenching, proton beam range, spot-intensity, spot-position in y-direction, and the integrity of Bragg-Peaks to analyze the imaging data 412 as described herein.

Computing device 402 also includes a number of components that perform specific tasks. In the exemplary aspect, computing device 402 includes a data storage device 430, an imaging acquisition component 440, a dosimetry extraction component 450, and communication component 460. Data storage device 430 is configured to store data received or generated by computing device 402, such as any of the data stored in database 410 or any outputs of processes implemented by any component of computing device 402. The imaging acquisition component 440 is configured to acquire the imaging data as disclosed herein. The dosimetry extraction component 450 is configured to quantify a radiation beam dose in a subject as described herein.

Communication component 460 is configured to enable communications between computing device 402 and other devices (e.g., user computing device 330, shown in FIG. 1) over a network, such as network 350 (shown in FIG. 1), or a plurality of network connections using predefined network protocols such as TCP/IP (Transmission Control Protocol/Internet Protocol).

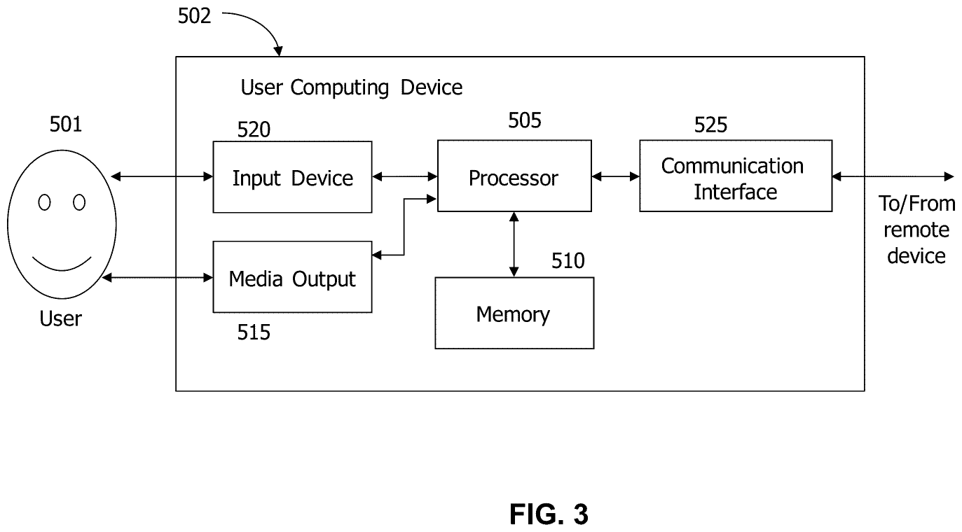

FIG. 3 depicts a configuration of a remote or user-computing device 502, such as user computing device 330 (shown in FIG. 1). Computing device 502 may include a processor 505 for executing instructions. In some aspects, executable instructions may be stored in a memory area 510. Processor 505 may include one or more processing units (e.g., in a multi-core configuration). Memory area 510 may be any device allowing information such as executable instructions and/or other data to be stored and retrieved. Memory area 510 may include one or more computer-readable media.

Computing device 502 may also include at least one media output component 515 for presenting information to a user 501. Media output component 515 may be any component capable of conveying information to user 501. In some aspects, media output component 515 may include an output adapter, such as a video adapter and/or an audio adapter. An output adapter may be operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some aspects, media output component 515 may be configured to present an interactive user interface (e.g., a web browser or client application) to user 501.

In some aspects, computing device 502 may include an input device 520 for receiving input from user 501. Input device 520 may include, for example, a keyboard, a pointing device, a mouse, a stylus, a touch-sensitive panel (e.g., a touchpad or a touch screen), a camera, a gyroscope, an accelerometer, a position detector, and/or an audio input device. A single component such as a touch screen may function as both an output device of media output component 515 and input device 520.

Computing device 502 may also include a communication interface 525, which may be communicatively couplable to a remote device. Communication interface 525 may include, for example, a wired or wireless network adapter or a wireless data transceiver for use with a mobile phone network (e.g., Global System for Mobile communications (GSM), 3G, 4G, or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server. A client application allows users 501 to interact with a server application associated with, for example, a vendor or business.

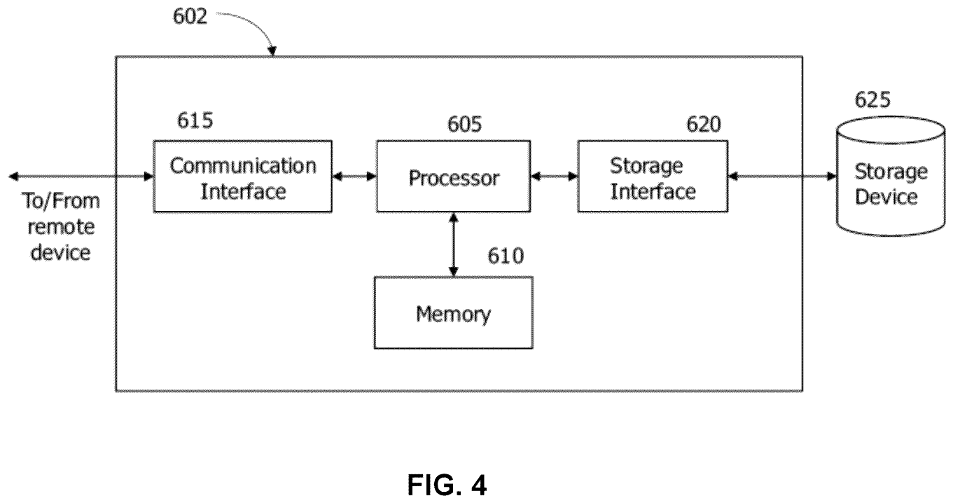

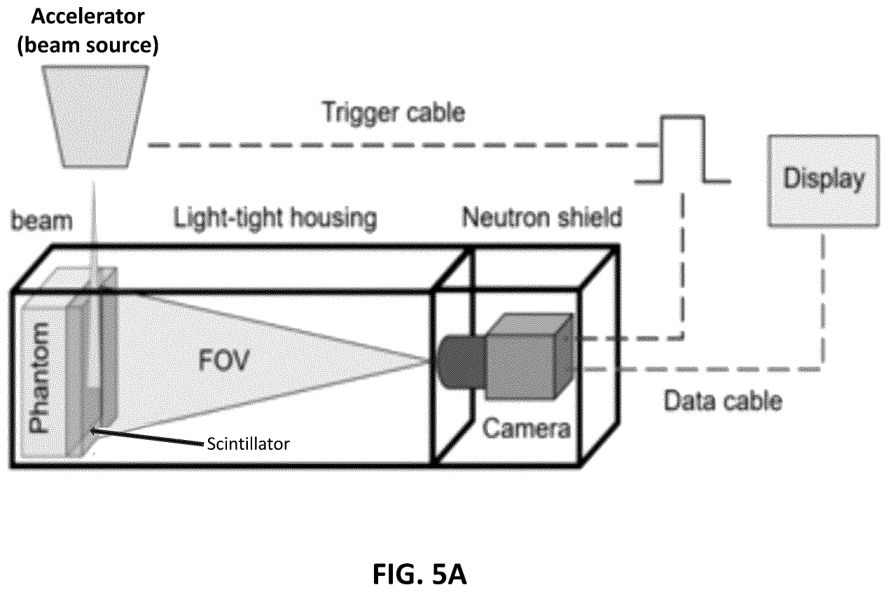

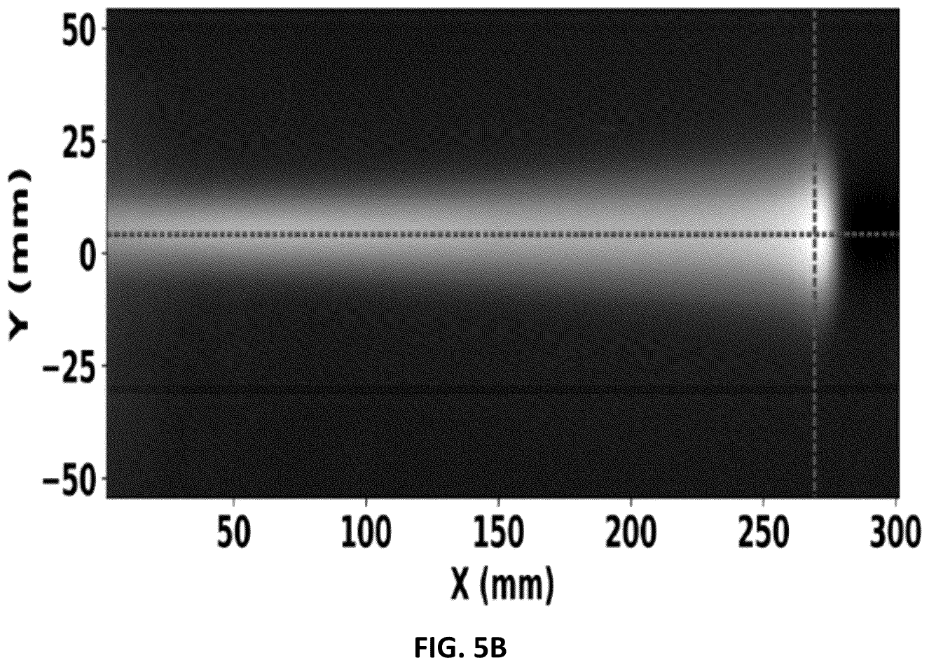

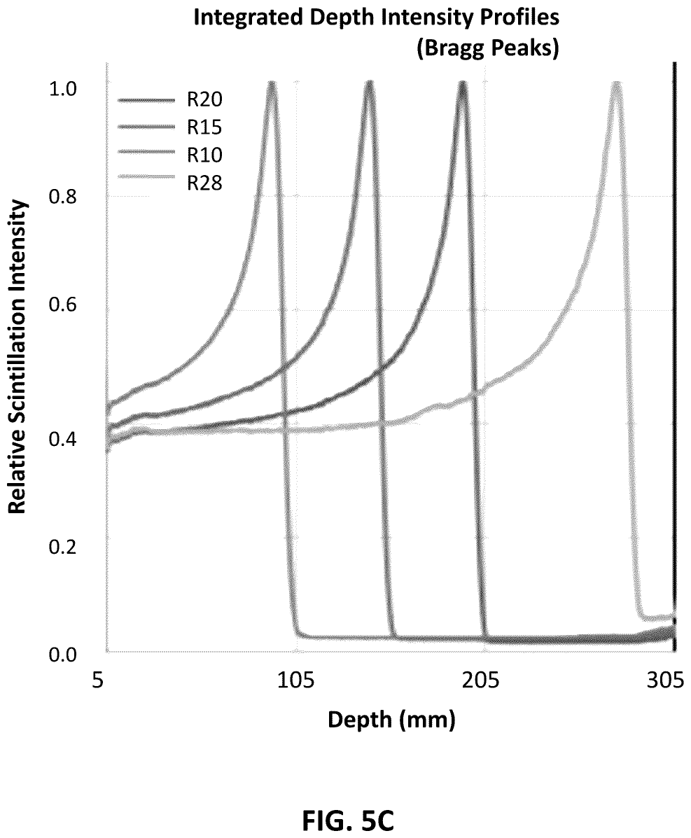

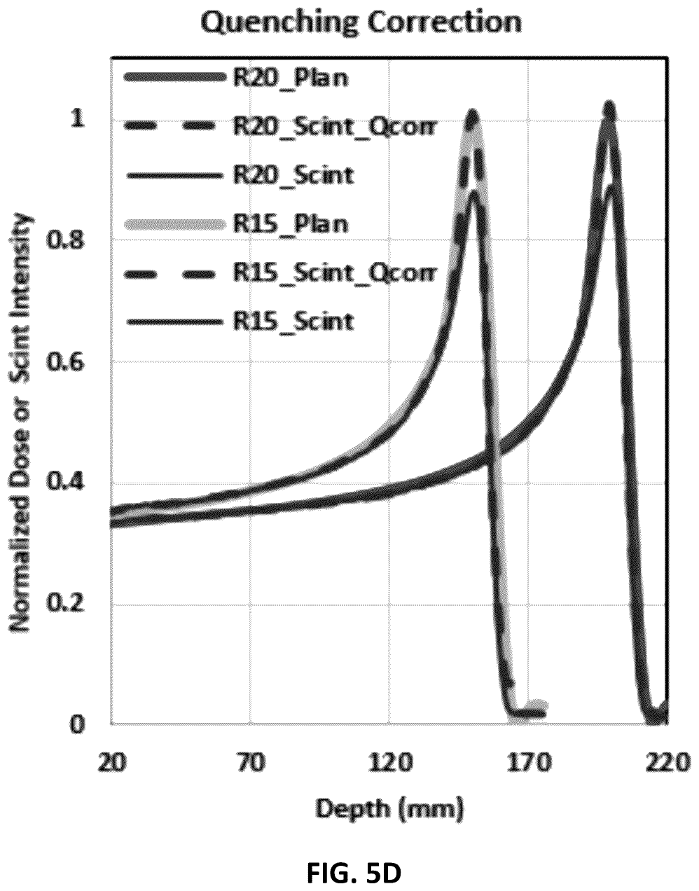

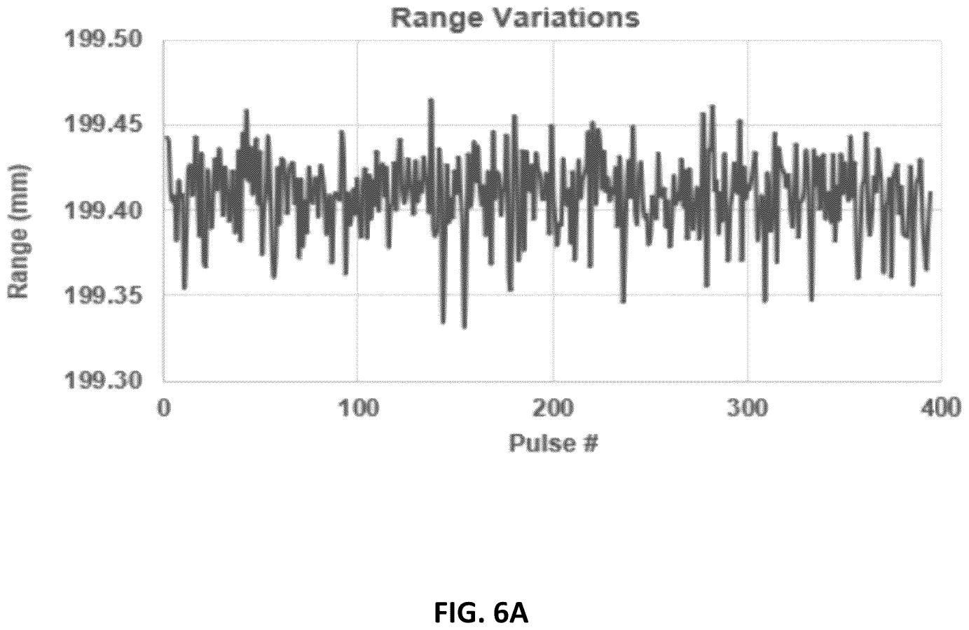

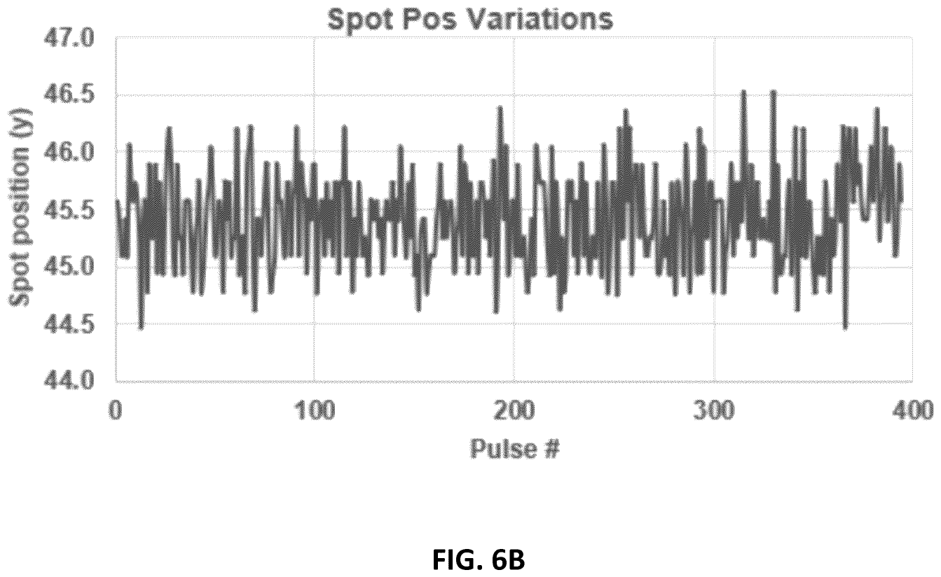

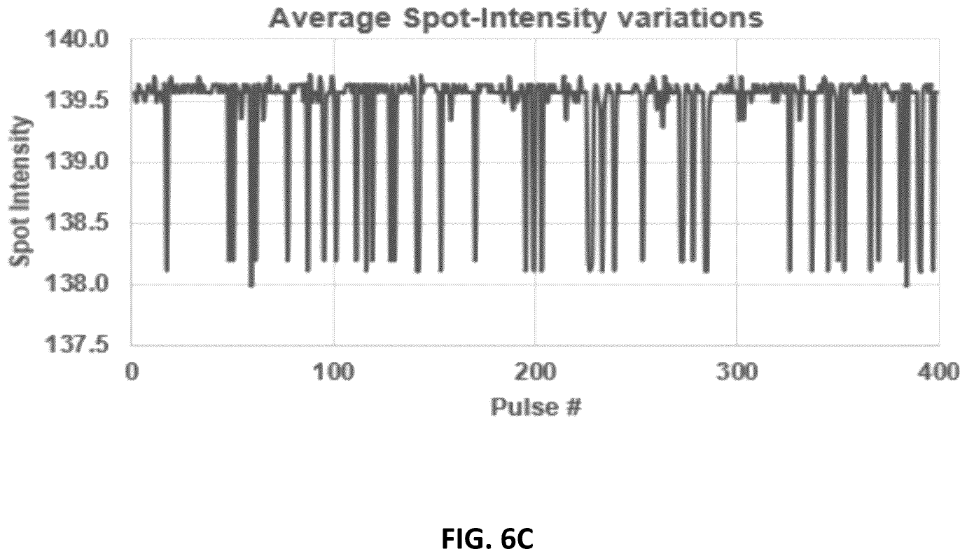

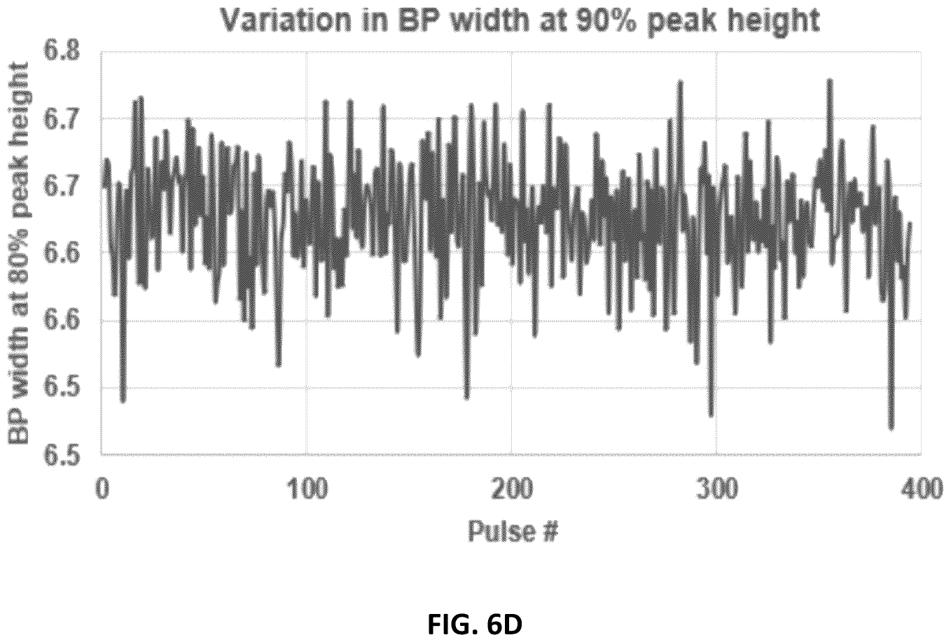

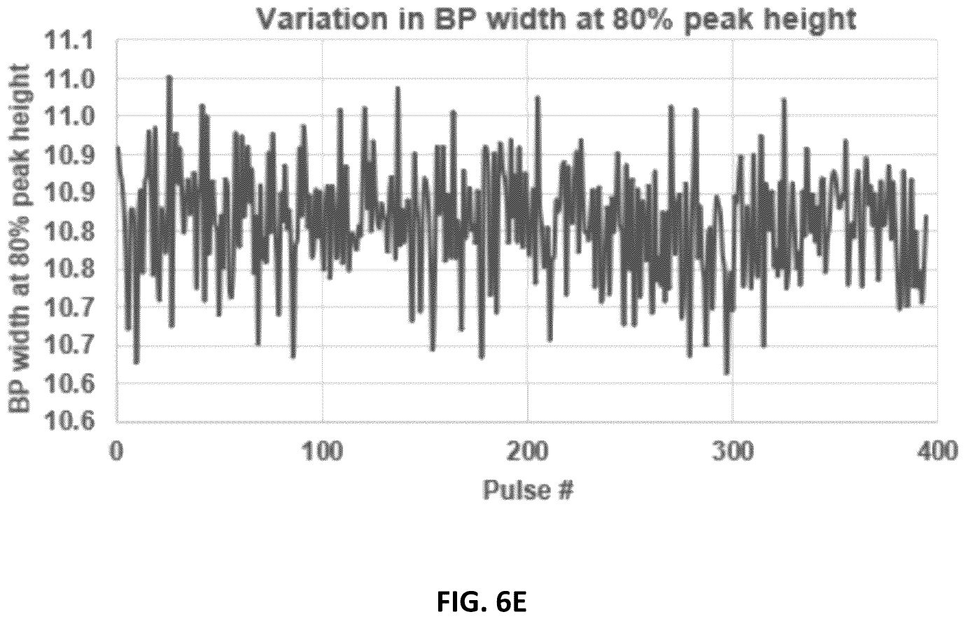

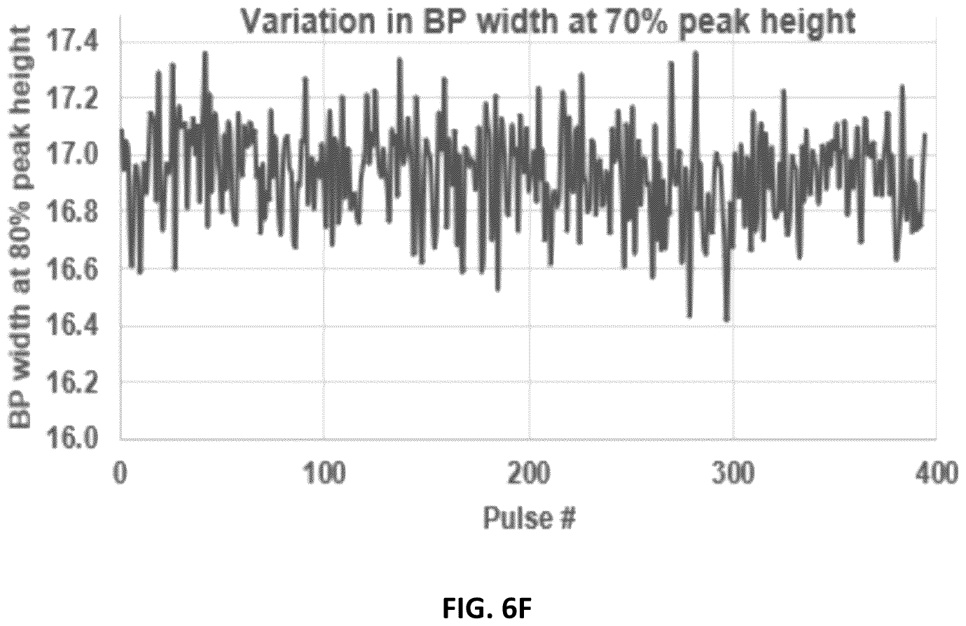

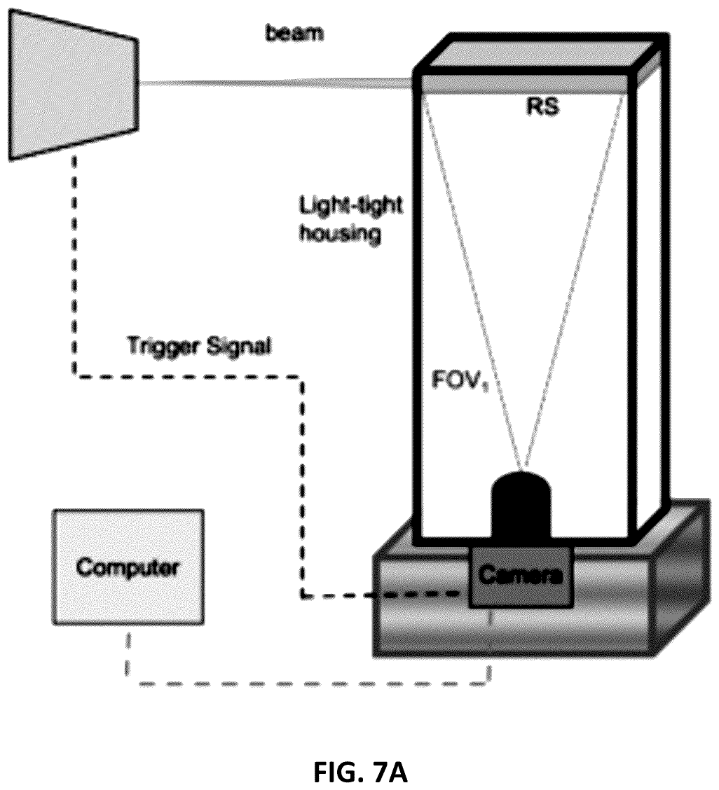

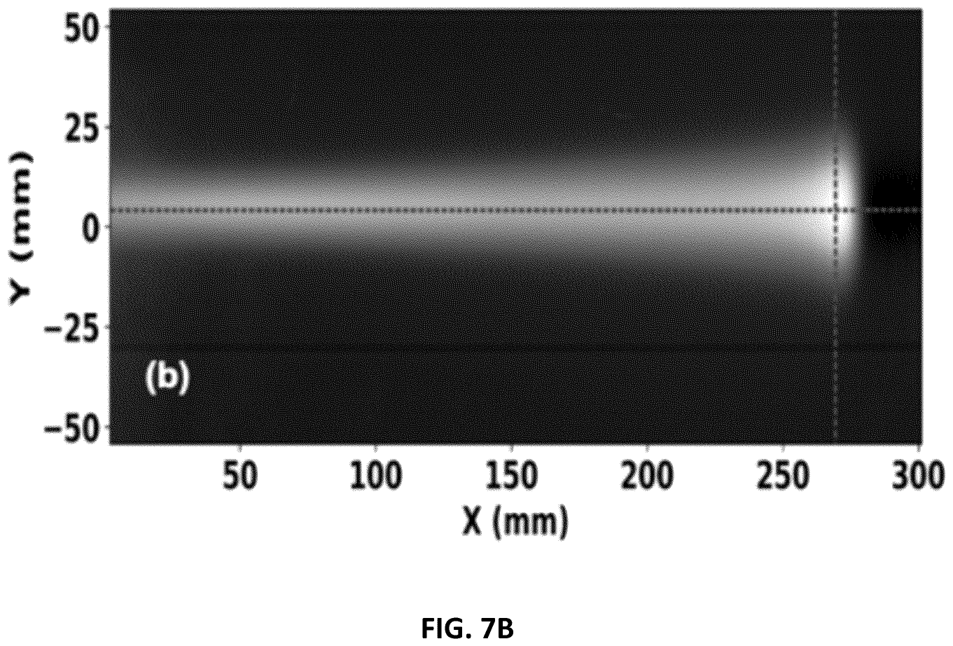

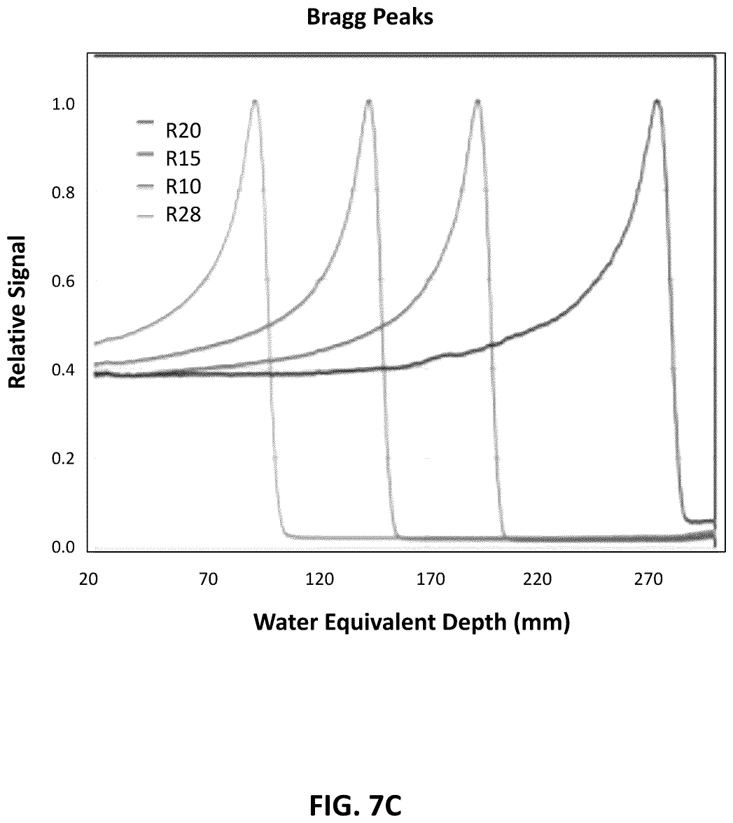

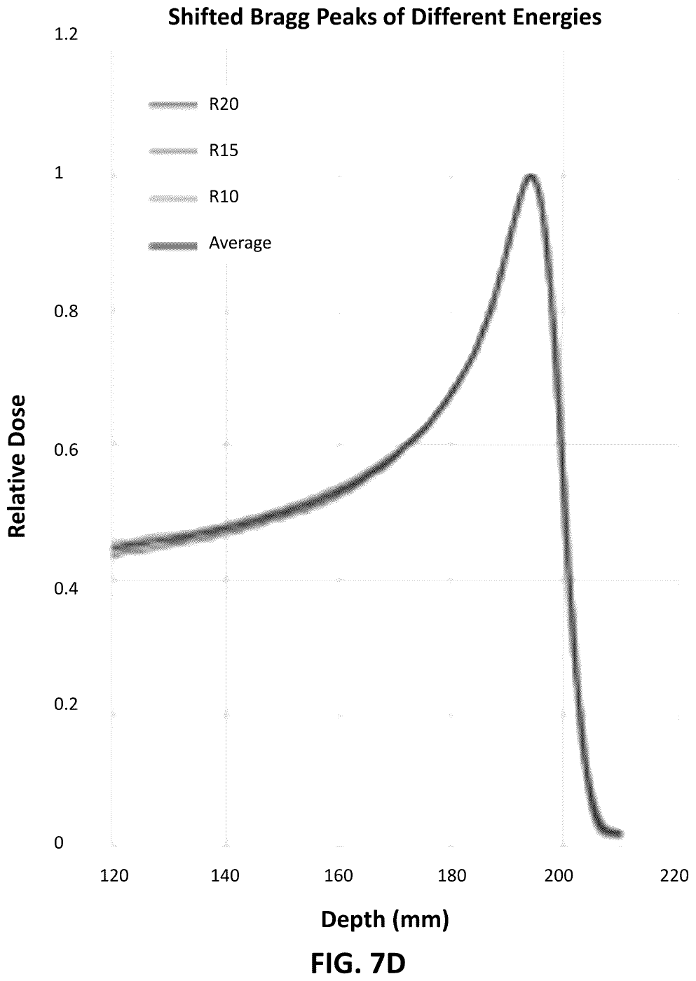

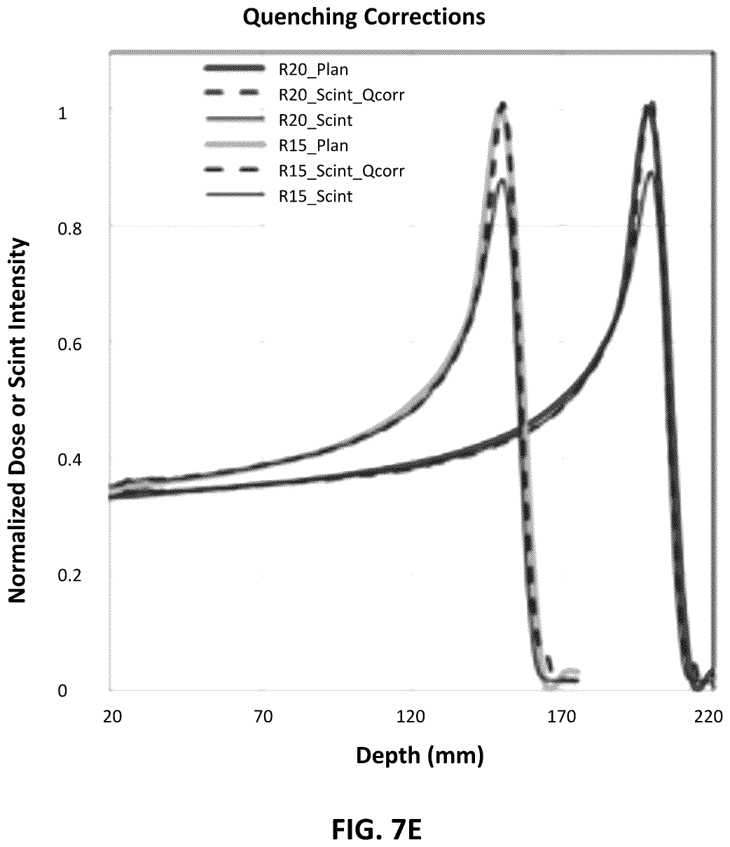

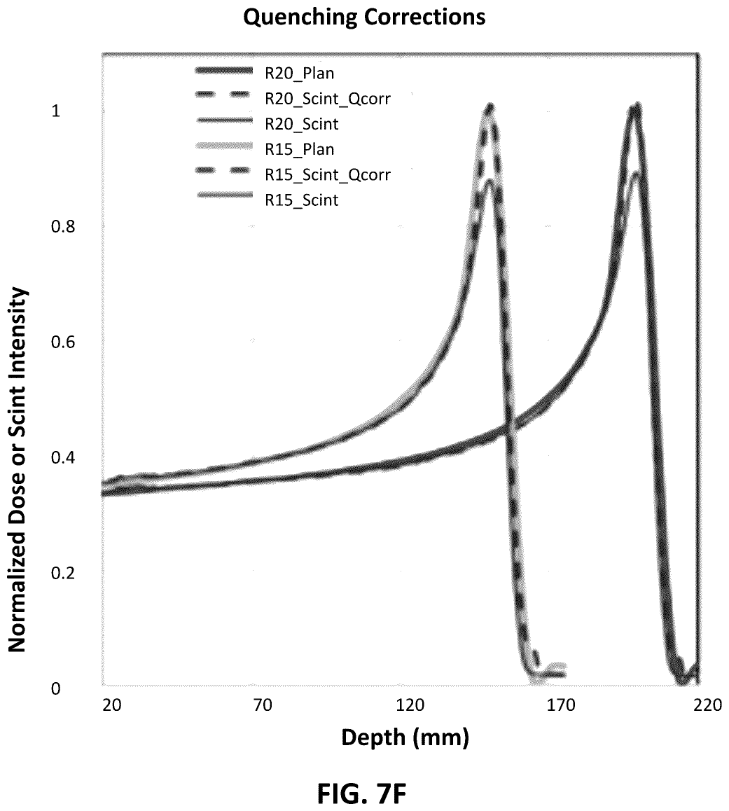

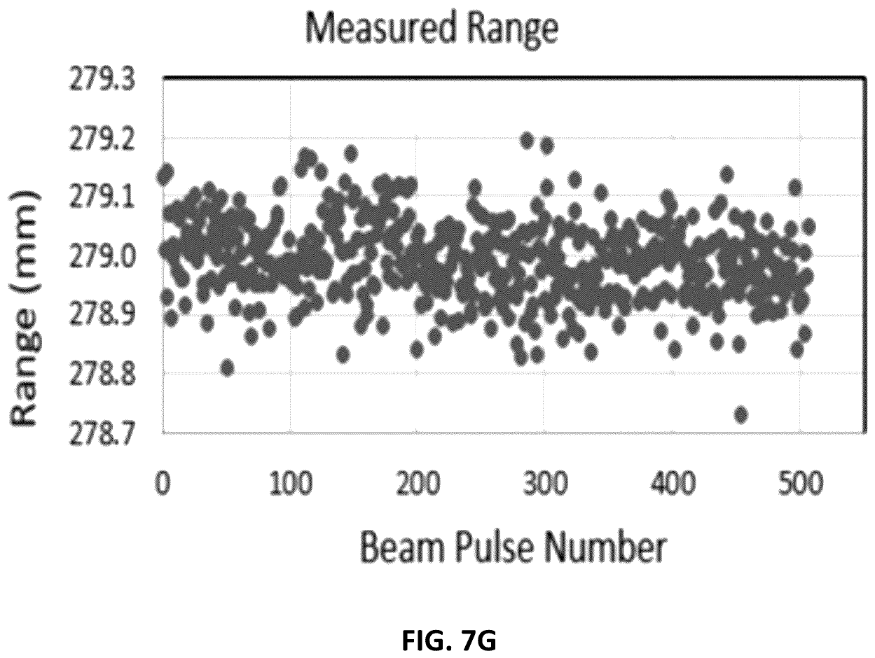

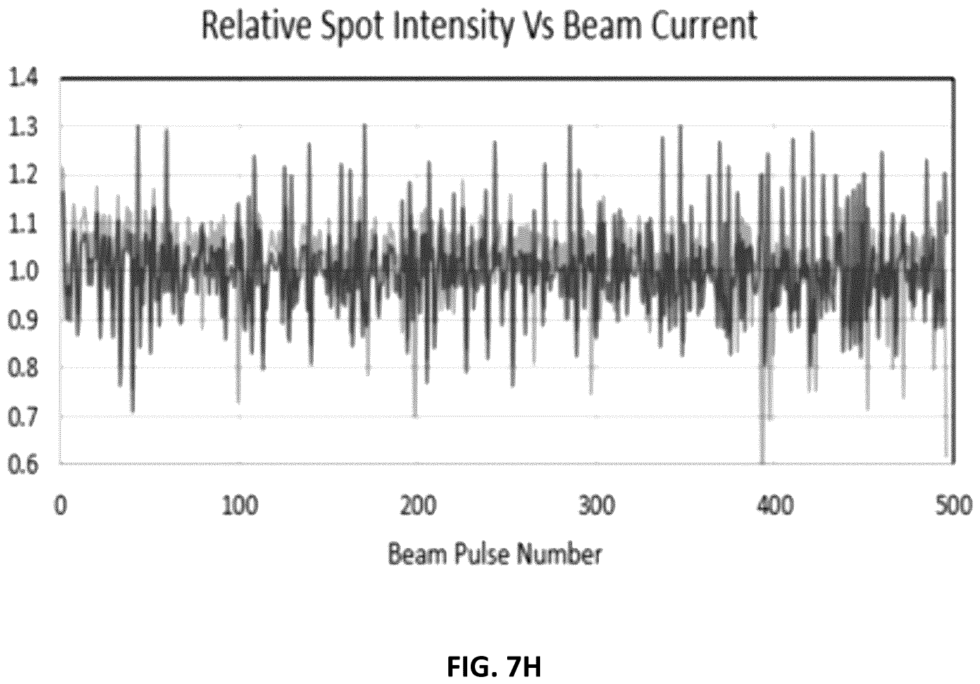

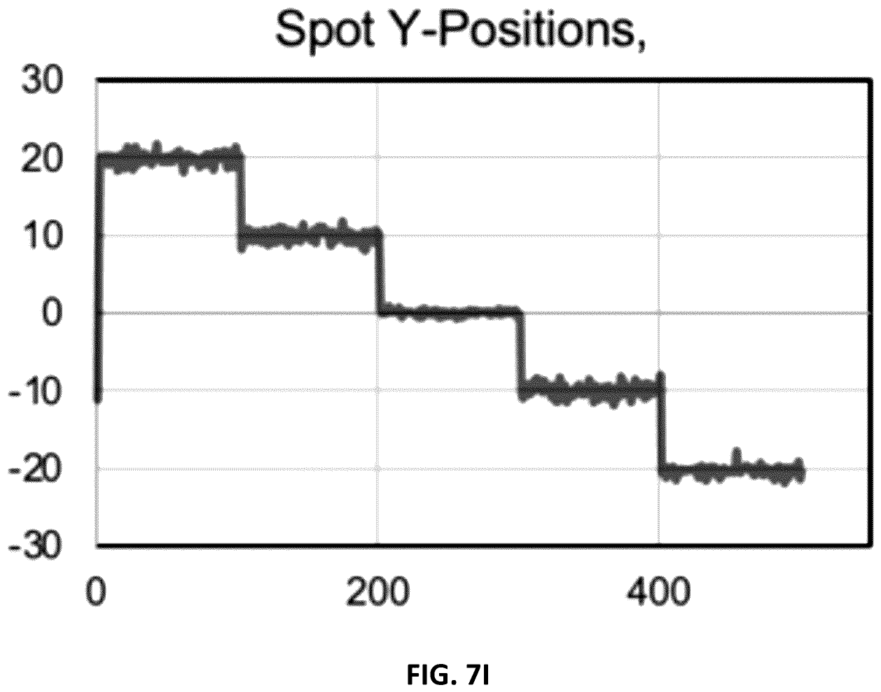

FIG. 4 illustrates an example configuration of a server system 602. Server system 602 may include, but is not limited to, database server 306 and computing device 302 (both shown in FIG. 1). In some aspects, server system 602 is similar to server system 304 (shown in FIG. 1). Server system 602 may include a processor 605 for executing instructions. Instructions may be stored in a memory area 625, for example. Processor 605 may include one or more processing units (e.g., in a multi-core configuration).

Processor 605 may be operatively coupled to a communication interface 615 such that server system 602 may be capable of communicating with a remote device such as user computing device 330 (shown in FIG. 1) or another server system 602. For example, communication interface 615 may receive requests from user computing device 330 via a network 350 (shown in FIG. 1).

Processor 605 may also be operatively coupled to a storage device 625. Storage device 625 may be any computer-operated hardware suitable for storing and/or retrieving data. In some aspects, storage device 625 may be integrated in server system 602. For example, server system 602 may include one or more hard disk drives as storage device 625. In other aspects, storage device 625 may be external to server system 602 and may be accessed by a plurality of server systems 602. For example, storage device 625 may include multiple storage units such as hard disks or solid-state disks in a redundant array of inexpensive disks (RAID) configuration. Storage device 625 may include a storage area network (SAN) and/or a network attached storage (NAS) system.

In some aspects, processor 605 may be operatively coupled to storage device 625 via a storage interface 620. Storage interface 620 may be any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Memory areas 510 (shown in FIG. 3) and 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on vehicle or mobile devices, or associated with smart infrastructure or remote servers), and/or via computer executable instructions stored on non-transitory computer-readable media or medium.

In some aspects, a computing device is configured to implement machine learning, such that the computing device “learns” to analyze, organize, and/or process data without being explicitly programmed. Machine learning may be implemented through machine learning (ML) methods and algorithms. In one aspect, a machine learning (ML) module is configured to implement ML methods and algorithms. In some aspects, ML methods and algorithms are applied to data inputs and generate machine learning (ML) outputs. Data inputs may further include: sequencing data, sensor data, image data, video data, telematics data, authentication data, authorization data, security data, mobile device data, geolocation information, transaction data, personal identification data, financial data, usage data, weather pattern data, “big data” sets, and/or user preference data. In some aspects, data inputs may include certain ML outputs.

In some aspects, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, dimensionality reduction, and support vector machines. In various aspects, the implemented ML methods and algorithms are directed toward at least one of a plurality of categorizations of machine learning, such as supervised learning, unsupervised learning, and reinforcement learning.

In one aspect, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function that maps outputs to inputs and utilize the predictive function to generate ML outputs based on data inputs. The example inputs and example outputs of the training data may include any of the data inputs or ML outputs described above.

In another aspect, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship.

In yet another aspect, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate an ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In one aspect, an ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict a user selection.

The methods and algorithms of the invention may be enclosed in a controller or processor. Furthermore, methods and algorithms of the present invention, can be embodied as a computer implemented method or methods for performing such computer-implemented method or methods, and can also be embodied in the form of a tangible or non-transitory computer readable storage medium containing a computer program or other machine-readable instructions (herein “computer program”), wherein when the computer program is loaded into a computer or other processor (herein “computer”) and/or is executed by the computer, the computer becomes an apparatus for practicing the method or methods. Storage media for containing such computer program include, for example, floppy disks and diskettes, compact disk (CD)-ROMs (whether or not writeable), DVD digital disks, RAM and ROM memories, computer hard drives and back-up drives, external hard drives, “thumb” drives, and any other storage medium readable by a computer. The method or methods can also be embodied in the form of a computer program, for example, whether stored in a storage medium or transmitted over a transmission medium such as electrical conductors, fiber optics or other light conductors, or by electromagnetic radiation, wherein when the computer program is loaded into a computer and/or is executed by the computer, the computer becomes an apparatus for practicing the method or methods. The method or methods may be implemented on a general purpose microprocessor or on a digital processor specifically configured to practice the process or processes. When a general-purpose microprocessor is employed, the computer program code configures the circuitry of the microprocessor to create specific logic circuit arrangements. Storage medium readable by a computer includes medium being readable by a computer per se or by another machine that reads the computer instructions for providing those instructions to a computer for controlling its operation. Such machines may include, for example, machines for reading the storage media mentioned above.

### Therapeutic Methods

Also provided is a process of treating, preventing, or reversing cancer in a subject in need of administration of a therapeutically effective amount of radiation, so as to spare healthy tissues while maintaining an effective anti-tumor effect.

Methods described herein are generally performed on a subject in need thereof. A subject in need of the therapeutic methods described herein can be a subject having, diagnosed with, suspected of having, or at risk for developing cancer. A determination of the need for treatment will typically be assessed by a history, physical exam, or diagnostic tests consistent with the disease or condition at issue. Diagnosis of the various conditions treatable by the methods described herein is within the skill of the art. The subject can be an animal subject, including a mammal, such as horses, cows, dogs, cats, sheep, pigs, mice, rats, monkeys, hamsters, guinea pigs, and humans or chickens. For example, the subject can be a human subject.

Generally, a safe and effective amount of radiation is, for example, an amount that would cause the desired therapeutic effect in a subject while minimizing undesired side effects. In various embodiments, an effective amount of radiation described herein can substantially inhibit cancer, slow the progress of cancer, or limit the development of cancer.

According to the methods described herein, administration can be parenteral, pulmonary, oral, topical, intradermal, intramuscular, intraperitoneal, intravenous, intratumoral, intrathecal, intracranial, intracerebroventricular, subcutaneous, intranasal, epidural, ophthalmic, buccal, or rectal administration.

When used in the treatments described herein, a therapeutically effective amount of radiation can be employed by FLASH-RT. For example, the radiation of the present disclosure can be administered, at a reasonable benefit/risk ratio applicable to any medical treatment, in a sufficient amount to irradiate a tumor in a subject.

Toxicity and therapeutic efficacy of radiation described herein can be determined by standard pharmaceutical procedures in cell cultures or experimental animals for determining the LD₅₀ (the dose lethal to 50% of the population) and the ED₅₀, (the dose therapeutically effective in 50% of the population). The dose ratio between toxic and therapeutic effects is the therapeutic index that can be expressed as the ratio LD₅₀/ED₅₀, where larger therapeutic indices are generally understood in the art to be optimal.

The specific therapeutically effective dose level for any particular subject will depend upon a variety of factors including the disorder being treated and the severity of the disorder; activity of the specific compound employed; the specific composition employed; the age, body weight, general health, sex and diet of the subject; the time of administration; the route of administration; the duration of the treatment; drugs used in combination or coincidental with the specific radiation employed; and like factors well known in the medical arts (see e.g., Koda-Kimble et al. (2004) Applied Therapeutics: The Clinical Use of Drugs, Lippincott Williams & Wilkins, ISBN 0781748453; Winter (2003) Basic Clinical Pharmacokinetics, 4th ed., Lippincott Williams & Wilkins, ISBN 0781741475; Sharqel (2004) Applied Biopharmaceutics & Pharmacokinetics, McGraw-Hill/Appleton & Lange, ISBN 0071375503). For example, it is well within the skill of the art to start doses of radiation at levels lower than those required to achieve the desired therapeutic effect and to gradually increase the dosage until the desired effect is achieved. If desired, the effective daily dose may be divided into multiple doses for purposes of administration. Consequently, single dose may contain such amounts or submultiples thereof to make up the daily dose. It will be understood, however, that the total daily usage of the radiation of the present disclosure will be decided by an attending physician within the scope of sound medical judgment.

Again, each of the states, diseases, disorders, and conditions, described herein, as well as others, can benefit from radiation and methods described herein. Generally, treating a state, disease, disorder, or condition includes preventing, reversing, or delaying the appearance of clinical symptoms in a mammal that may be afflicted with or predisposed to the state, disease, disorder, or condition but does not yet experience or display clinical or subclinical symptoms thereof. Treating can also include inhibiting the state, disease, disorder, or condition, e.g., arresting or reducing the development of the disease or at least one clinical or subclinical symptom thereof. Furthermore, treating can include relieving the disease, e.g., causing regression of the state, disease, disorder, or condition or at least one of its clinical or subclinical symptoms. A benefit to a subject to be treated can be either statistically significant or at least perceptible to the subject or to a physician.

Administration of radiation can occur as a single event or over a time course of treatment. For example, radiation can be administered daily, weekly, bi-weekly, or monthly. For treatment of acute conditions, the time course of treatment will usually be at least several days. Certain conditions could extend treatment from several days to several weeks. For example, treatment could extend over one week, two weeks, or three weeks. For more chronic conditions, treatment could extend from several weeks to several months or even a year or more.

Treatment in accord with the methods described herein can be performed prior to, concurrent with, or after conventional treatment modalities for cancer.

Radiation can be administered simultaneously or sequentially with another agent, such as an antibiotic, an anti-inflammatory, or another agent. For example, radiation can be administered simultaneously with an agent, such as an antibiotic or an anti-inflammatory. Simultaneous administration can occur through administration of radiation, an antibiotic, an anti-inflammatory, or another agent. Radiation can be administered sequentially with an antibiotic, an anti-inflammatory, or another agent. For example, radiation can be administered before or after administration of an antibiotic, an anti-inflammatory, or another agent.

A control sample or a reference sample as described herein can be a sample from a healthy subject. A reference value can be used in place of a control or reference sample, which was previously obtained from a healthy subject or a group of healthy subjects. A control sample or a reference sample can also be a sample with a known amount of a detectable compound or a spiked sample.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range.

Unless otherwise indicated herein, each individual value is incorporated into the specification as if it were individually recited herein. The recitation of discrete values is understood to include ranges between each value.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

All publications, patents, patent applications, and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1-Synchronized High Resolution Scintillation Imaging Dosimetry of Proton Flash Pencil Beams on a Pulse-by-Pulse Basis

### Purpose

Radiotherapy at ultra-high dose rates (FLASH-RT) is promising and gaining popularity but its dosimetry is challenging due to high instantaneous dose rates. It has shown great promise in sparing healthy tissues while maintaining the same anti-tumor effect. Due to short beam delivery time and small radiation fields involved, there is a need for dosimeters with high spatiotemporal resolution for pre-clinical studies and clinical trials. Scintillation imaging when synchronized with the accelerators' pulse train can provide high spatial resolution (pulse-by-pulse). In Example 1, the feasibility of utilizing scintillation imaging for relative dosimetry at high-spatiotemporal resolutions is demonstrated.

### Methods

A high-resolution scintillation imaging system capable of pulse-by-pulse dosimetry of PBS-RT at high-resolution is described herein. The systems include a 5 cm thick BC-408 plastic-scintillator-detector (PSD), with 30×30 cm² cross-sectional area, facing a high-speed CMOS-camera placed in an optically sealed enclosure. The camera's shutter was synchronized with the synchrocyclotron's beam-pulse-train to capture scintillation images. As pencil beam of protons pass through the scintillator the camera captured every beam-pulse as an image. Five different proton energies were tested by delivering 400 pulses (16-20 pC/pulse) at each on central-axis at 750 Hz. All the images were processed after correcting for background noise. Integrated depth-intensity (IDI) curves were extracted and corrected for ionization-quenching. Proton beam range, spot-intensity, and spot-position in y-direction were tested. In order to study the integrity of Bragg-Peaks, widths of IDI curves at 90%, 80% and 70% of peak height were evaluated.

### Results

The high-speed camera was able to capture scintillation images corresponding to all individual beam-pulses (within +1%) with a spatial resolution of 15 cm with a maximum deviation of +2.6 mm for the short range of 5 cm. The average spot-intensities are mostly consistent with few exceptions requiring further investigation. It is shown that pulse-by-pulse scintillation imaging (at 750 Hz) using a high-speed CMOS camera is possible when the camera was gated with the synchrocyclotron's ion source pulse. The heuristic method worked successfully to correct for the ionization quenching in the scintillator. Analysis of the corrected frames showed inter-pulse variation of the range, spot position (axial and lateral) within xxx mm. The device provides researchers a tool for proton FLASH dosimetry with high spatiotemporal resolution. Therefore, scintillation imaging of FLASH beams at very high spatiotemporal resolution is feasible and may help in acceptance testing and commissioning of emerging technologies such as FLASH, Grid, mini beams, and related technologies.

### Example 2-High Spatiotemporal Resolution Scintillation Imaging of Pulsed Pencil Beam Scanning Proton Beams Produced by a Gantry-Mounted Synchrocyclotron

### Summary of Example 2

### Background

A dosimeter with high spatial and temporal resolution would be of significant interest for pencil beam scanning (PBS) proton beams' characterization, especially when facing small fields and beams with high temporal dynamics. Optical imaging of scintillators has potential 20 in providing sub-millimeter spatial resolution with pulse-by-pulse basis temporal resolution when the imaging system is capable of operating in synchrony with the beam producing accelerator.

### Purpose

Example 2 demonstrates the feasibility of imaging PBS proton beams as they pass through a plastic scintillator detector to simultaneously obtain multiple beam parameters, including proton range, pencil beam widths at different depths, spot size, and spot position on a pulse-by-pulse basis with 25 sub-millimeter resolution.

### Materials and Methods

A PBS synchrocyclotron (Mevion HyperScan) was used for proton irradiation. Two BC-408 plastic scintillator blocks with 30 cm×30 cm×5 cm and 30 cm×30 cm×0.5 cm positioned in an optically sealed housing were used sequentially to measure the proton range, and spot size/location, respectively. A high-speed CMOS camera system faced the 5-cm thick scintillator directly or the 0.5-cm-thick scintillator through a 45° mirror. A gating module was used to synchronize the camera with the accelerator's pulses.

Scintillation images from the 5-cm-thick scintillator were corrected for background, and ionization quenching of the scintillator to obtain the proton range. Spots' position and size were obtained from the scintillation images of the 0.5-cm-thick scintillator reflected through the mirror toward the camera.

### Results

The camera captured scintillation images with 0.16 mm/pixel resolution corresponding to all proton pulses. Pulse-by-pulse analysis showed that variations of the range, spot-position and size were within +0.2% standard deviation of their average values. The absolute ranges were within +1 mm of their expected values. The average spot-positions were mostly within +0.9 mm and spot-sigma agreed within 0.16 mm of the expected values.

### Conclusion

Scintillation-imaging PBS beams with high-spatiotemporal resolution is feasible and may help in efficient and cost-effective acceptance testing and commissioning of existing and even emerging technologies such as FLASH, grid, mini-beams, and other related technologies.

In this work, feasibility of scintillation imaging of PBS proton beams, produced by a gantry-mounted synchrocyclotron, using a high-speed complimentary metal-oxide semiconductor (CMOS) camera for proton range, spot size, and position measurement 90 with high spatial resolution (0.16 mm/pixel, i.e. about an order of magnitude improvement compared to the previous study) on a pulse-by-pulse basis is shown. An additional experimental arrangement for proton spot's size and position measurement is also introduced in this Example.

### Detailed Description of Example 2

### Materials and Methods

### Proton Therapy System

A gantry-mounted PBS proton therapy synchrocyclotron (Hyperscan™, Mevion Medical Systems, Littleton, MA) was used for the present study. The synchrocyclotron accelerates protons to maximum energy of 227 MeV (32.2 cm range in water) before the beam is extracted. A series of 18 range shifter polycarbonate plastic plates were employed in the system to modulate the proton energy. The machine extracts the proton beam approximately 500 us after the ion-pulse signal, i.e., it takes 500 us for the hydrogen ions released at the center of the cyclotron to reach to the maximum 227 MeV energy and exit the cyclotron. The pulse frequency was set at 750 Hz corresponding to approximately 1.33 ms repetition time between each macro-pulse is delivered. Typical proton macro-pulses have approximately 5-20 μs width. The ion source signal with a delay (t1) less than 500 μs can be used as a trigger for the camera to open its shutter. Then, a recording time (t2) more than the individual pulse width but less than the pulse period (20 μs<t2<1.33 ms) can be set to close the camera's shutter. t1=350 μs and t2=980 μs were chosen herein. This is also referred to as time-gating, in which the shutter speed is about equal to the pulse frequency of the accelerator. In some embodiments, the time-gating of the system sets each camera shutter speed to be about equal to or less than the pulse frequency of the accelerator. In some embodiments, the matched shutter speed/pulse frequency ranges from about 200 Hz up to about 750 Hz.

For range measurement experiments, a single spot for each energy, corresponding to the nominal ranges of 5 cm, 10 cm, 15 cm, 20 cm, and 25 cm, was delivered on the central axis, each with 300-400 pulses. In addition, the off-axis pencil beams were also investigated by delivering 5 spots (with ranges 10-25 cm) vertically separated apart by 10 mm, i.e., y=+2.0, +1.0, 0.0, −1.0 and −2.0 cm.

For spot's location and size (sigma) measurements, a set of 49 spots with 10 mm separation was delivered over a 7×7 cm² square area. 50-100 pulses per spot were delivered in the experiments. The maximum energy beam was tested for the spot position and size evaluations. All measurements were performed in physics mode and the experiments were repeated at least 3 times.

### Scintillation Imaging Setup

The experiments were performed using a BC-408 (Saint-Gobain Crystals, Hiram, OH, USA) plastic scintillators composed of polyvinyl toluene doped with anthracene. Its mass density is 1.032 g/cm³, emission peak wavelength is ˜425 nm, rise times is 0.9 ns, and decay time is 2.1 ns. Two blocks of BC-408 were used, each with 30 cm×30 cm cross sectional area but one with 5 cm and the other with 0.5 cm thickness. All faces of these scintillator blocks have been polished. The 5-cm-thick scintillator (S1) was used for range measurements while the 0.5-cm-thick scintillator (S2) was used for spot size and position measurements.

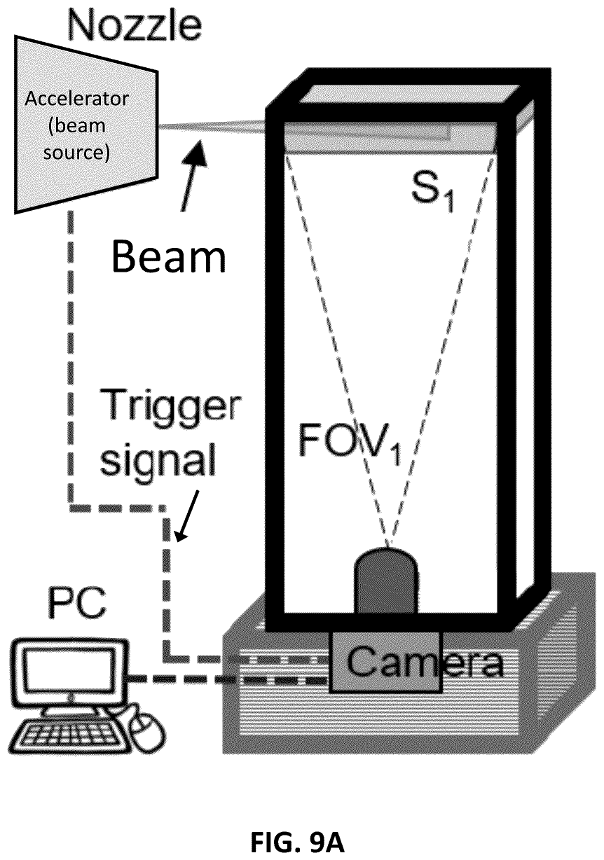

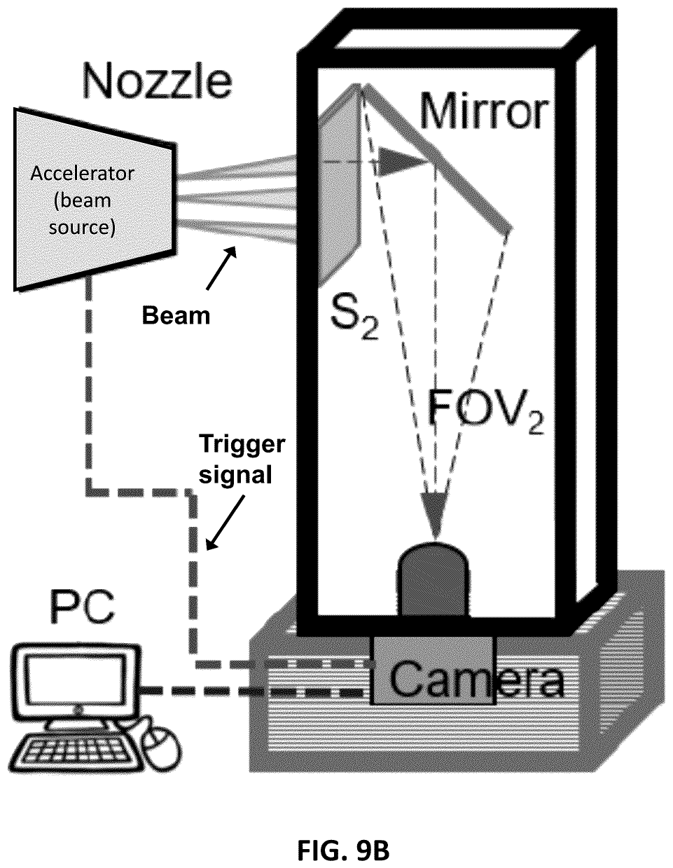

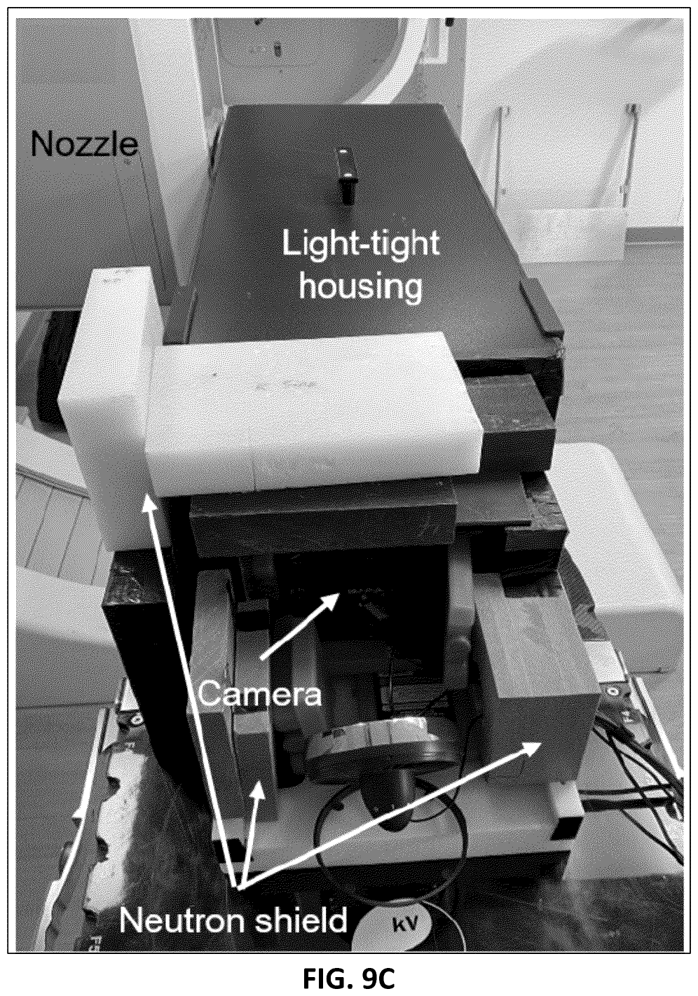

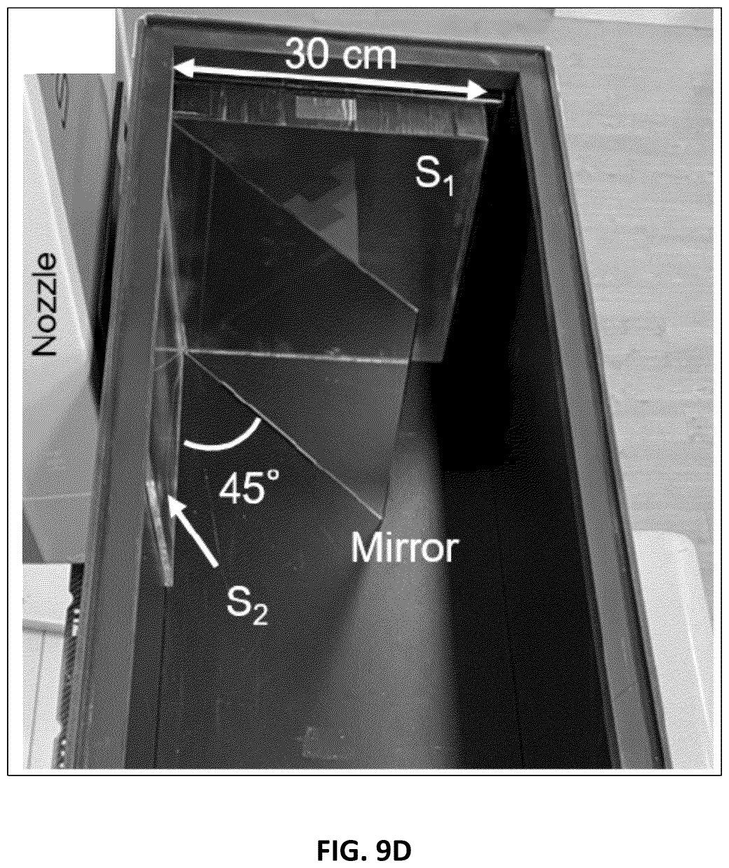

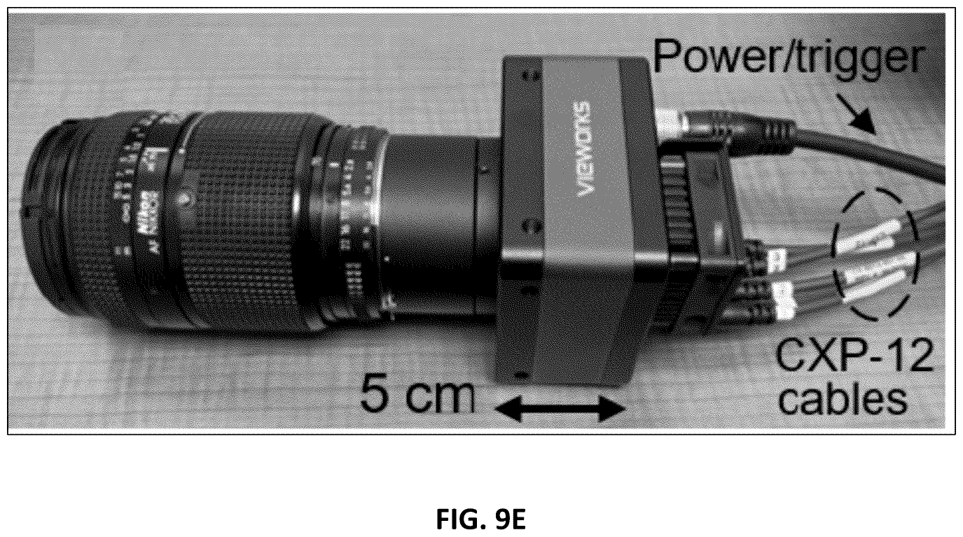

The experimental setup is shown in FIG. 9. Both scintillators were placed in an optically-sealed black plywood housing, with ˜5 mm wall thickness, but used sequentially in two arrangements: i) S1 directly faces the camera to capture images of the traversing proton beam pulses for range and spot intensity measurements, and ii) S2 is placed on the left side of the box, 130 i.e. at 90° from S1 for spot position and sigma measurements through a mirror placed at 45° angle with respect to S2 reflecting image from S2 toward the camera. The 0.5-cm-thick plastic scintillator was backed with another mirror to intensify the spot. For the S1 arrangement no mirrors were used.

A high-speed CMOS camera (ViewWorks VC12M, Vision Systems Technology, LLC, Vista, CA, USA) system with its associated software were used for scintillation imaging. It is capable of capturing 335 frames per second at full resolution of 4092×3072 pixels but it can capture at higher frame rates by limiting the number of rows. This camera includes a CMOS sensor with a pixel size of 5.4 μm×5.4 μm and utilizes Eurosis frame-grabber with four CXV-12 cables for high frame-rate data collection and transfer. A 2×2 binning is applied during image acquisition to achieve optimal signal intensity.

The camera was shielded from neutrons by a dual-layer shield composed of 2-inch-thick 30% borated polyethylene (BPE) as the inner layer, and a 2-inch-thick 5% BPE as the outer layer (see FIG. 9C). In order to minimize the neutron flux, the camera was placed perpendicular to the central axis of the beam at a distance of ˜1.1 m from the isocenter. The distance from the exit of the cyclotron to the treatment isocenter was 205 cm. In order to maintain camera's operating temperature and reduce thermal noise, a cooling system was built around the camera that includes CPU cooling fans and frozen gel packs.

The gantry was set to 90° for beam delivery (see FIGS. 9C and 9D). The camera system was synchronized with the synchrocyclotron. Individual frames were captured pulse-by-pulse until the beam was stopped. All images were saved in 8-bit TIFF format.

Background images, without the beam being on, were collected before and after each measurement to establish an average background image which then subtracted from the captured scintillation images. The images were processed in MATLAB® 165 (MathWorks, Natick, MA) to extract as many beam characteristics as possible.

### Scintillation Imaging

### Dose Response Linearity

Different monitor units (2 MU to 1000 MU) were delivered to the scintillator (S1 arrangement) and the data were collected on a pulse-by-pulse basis using the synchronized data acquisition technique. The intensities at 5 cm, 10 cm, depths and in the middle of the Bragg-peak was sampled on each image to establish the relationship between integrated signal and delivered MUs. A 30-pixels-radius region-of-interest was selected to determine the integrated intensities in each image and then added together to get the sum-intensities of each delivery. The primary objective was to assure that the scintillation intensity has a linear relationship with the delivered monitor units that shows the camera's ability to capture all of the beam pulses.

### Quenching Corrections

Ionization quenching refers to a phenomenon in which optical response of a scintillator does not keep up with the high LET radiation dose due to non-radiative deexcitations, and manifested as an under-response (typically ˜10-20%) in proton depth dose curves around the BP. In the Mevion system, due to the absence of an energy selection slit system, the energy spectrum around the residual range is similar for all energies, hence the slope of the distal shape of the BP. This property can be exploited to obtain a generic depth dependent correction factors for ionization quenching. In practice, such factors can be obtained by comparing the last 3 cm of a BP curve obtained through an ion chamber measurement to the one obtained through the scintillator. The pixel-by-pixel ratio between them is simply a multiplying correction factor.

### Geometry Correction

A geometric phantom with precisely known lengths was built and imaged to establish the scaling factors in both horizontal and vertical axes. Images of this phantom was taken before each measurement in order to convert pixel sizes into millimeters. The scaling factors for the measurement geometry were established and used to convert the pixel lengths of the scintillation images to millimeters. Non-linear scaling factors were established to account for any distortions that are present in the images.

### Proton Range Analysis

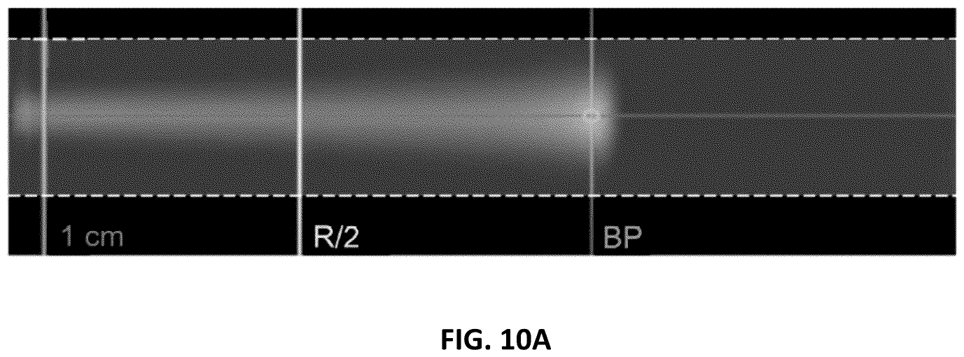

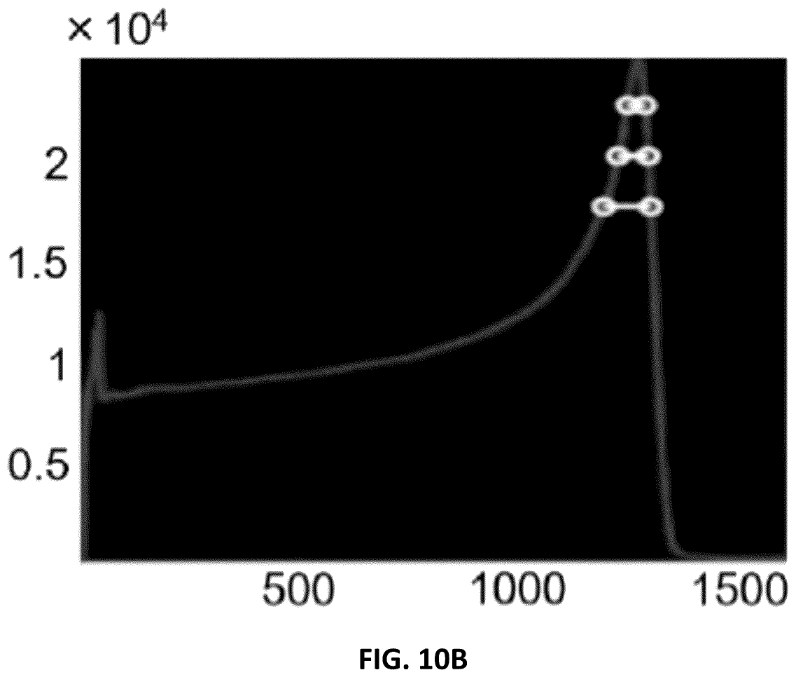

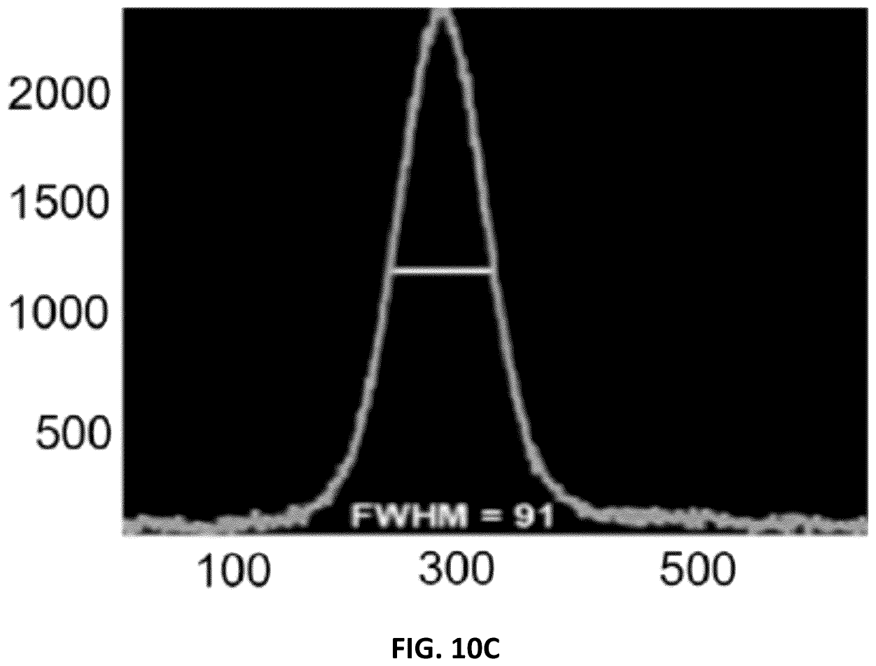

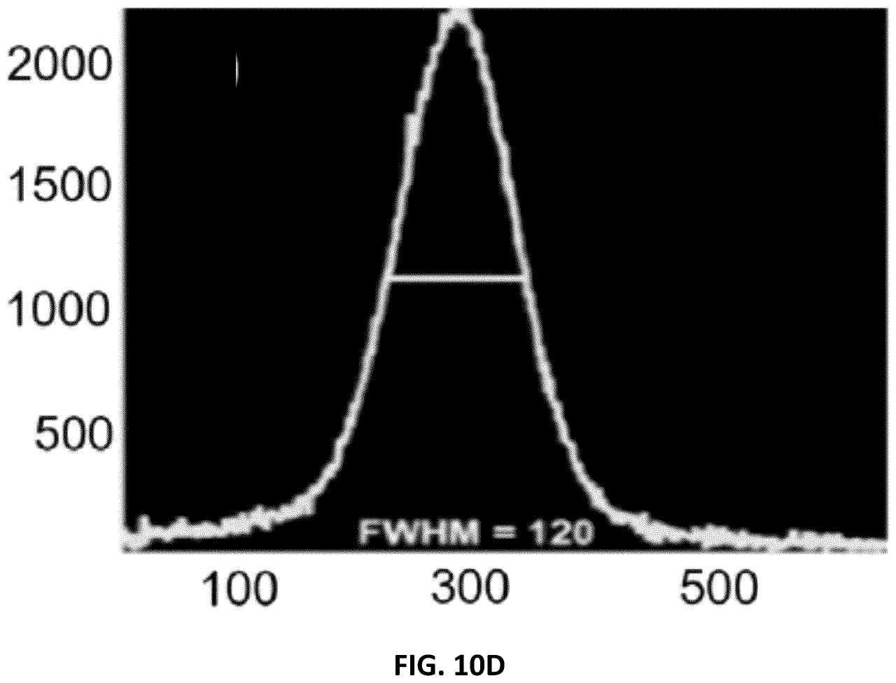

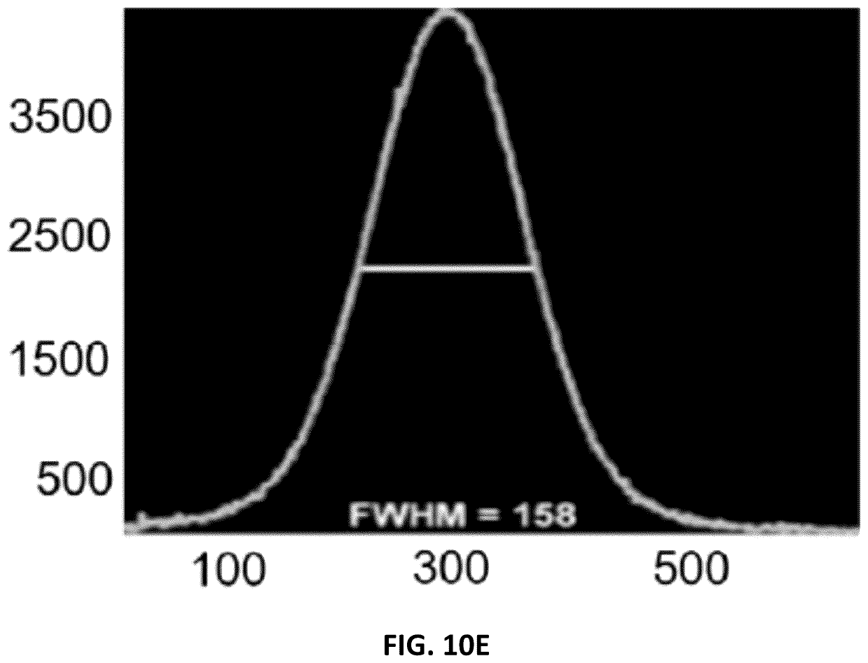

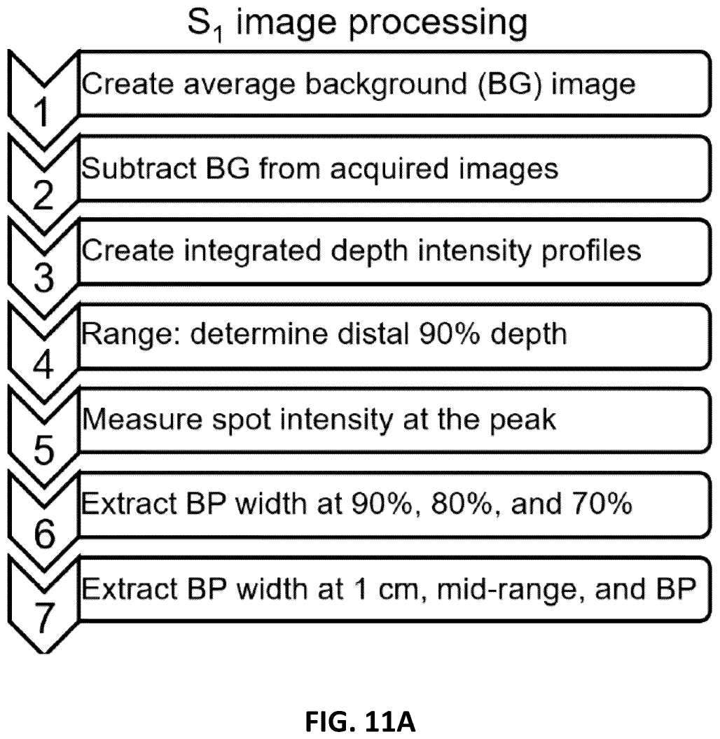

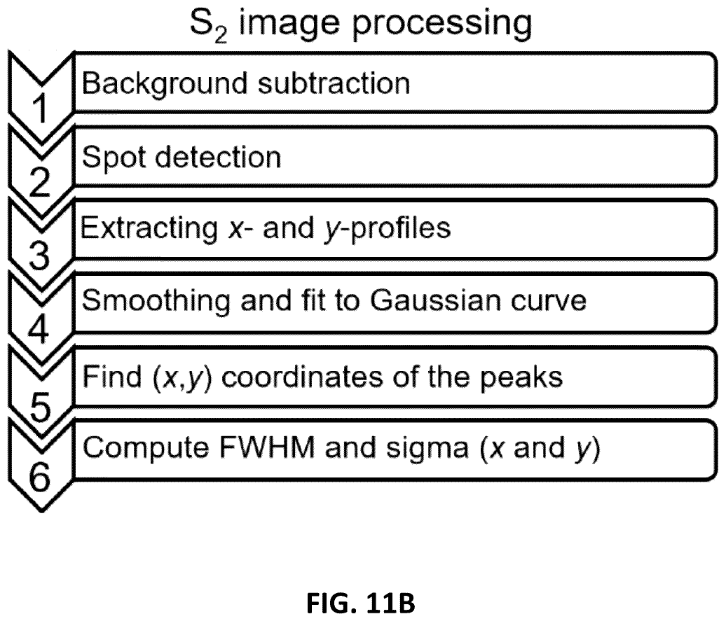

The first analysis step involved background subtraction. Thirty background (BG) images (beam-off) were collected to establish an average BG image and subtracted from the scintillation images. A software tool was developed to visualize pulse-by-pulse variations of different beam parameters as shown in FIG. 10. TIFF images representing individual beam pulses were analyzed to extract multiple beam parameters that include integrated depth intensity profile (IDI), spot intensity at the peak, and pencil beam widths at multiple depths as shown in FIG. 10. In addition, Bragg-peak widths 205 at 90%, 80% and 70% of the peak height were also measured to test the robustness of the derived IDI curves. The workflow of the digital image processing is shown in FIG. 11.

Integrated pixel intensity profiles along the beam's-axis (horizontal) were created by adding grey scale values of all rows around the central axis of the pencil beam covering the entire proton beam as indicated in FIG. 10A. Pixel intensities in each column in the selected region was added to get the integrated signal and assigned to their corresponding pixel depth. Proton range was defined as the distal point at 90% of the BP. Relative spot intensities at the peak were sampled by integrating the pixel values within 30 pixel radius (see the green circle in FIG. 10A). Vertical profiles were drawn to determine the pencil beam widths at the entrance (1 cm depth), mid-range (R/2), and at the BP and were fitted to a Gaussian model to measure the full-width at half-maximum (FWHM).

### Spot Size and Position Analysis

Spot analysis was performed by scanning 49 spots, with maximum proton energy, in 7 rows and 7 columns with 1 cm separation under the second setup (S2). A total number of 10,715 pulses at 49 spot locations were recorded and analyzed. The workflow of the image analysis for S2 arrangement is described in FIG. 11B. Similar to the S1-arrangement's images, the background subtraction was performed. The intensity profiles along x—and y-axes were plotted and a Gaussian curve was fit to each of them. The FWHM of each profile was calculated and the sigma (Ox and Oy) of each image corresponding to each pulse was obtained in this way. Relative position of each spot was basically the peak position of the fitted intensity profile in x and y direction relative to the central spot, i.e., spot #25.

### Results

### MU Linearity

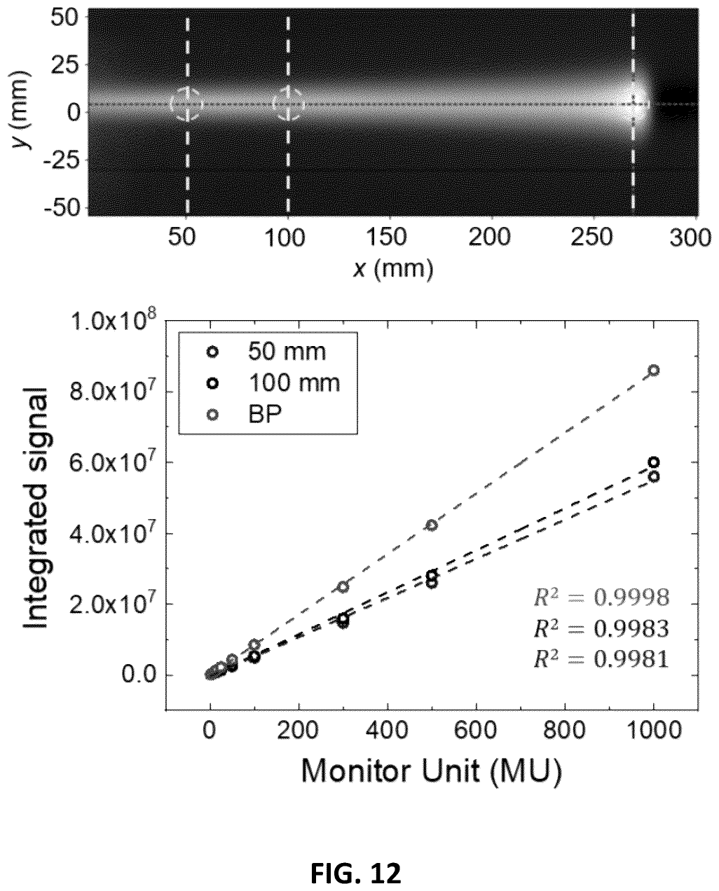

The inset in FIG. 4 shows a typical scintillation image obtained under the first setup (S1) after background subtraction and smoothing for a proton beam with a range of 28 cm. A linear relationship between the measured scintillation signal and the delivered monitor units can be seen in FIG. 12. The linearity was observed at all three selected depths as shown by the regression coefficients in the inset of FIG. 12 indicating that the camera system was able to capture all the individual beam pulses during the delivery making it promising for quantitative dosimetry evaluations.

### Ionization Quenching Correction

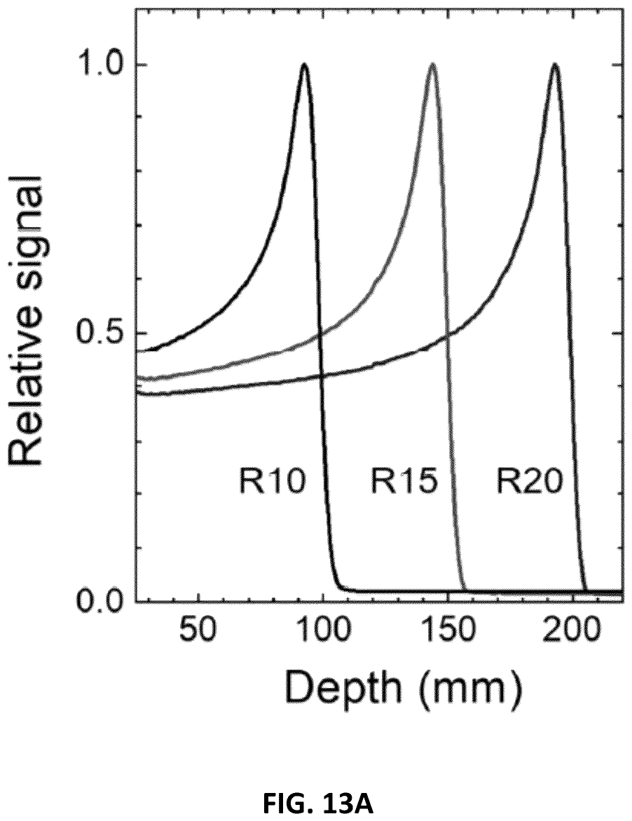

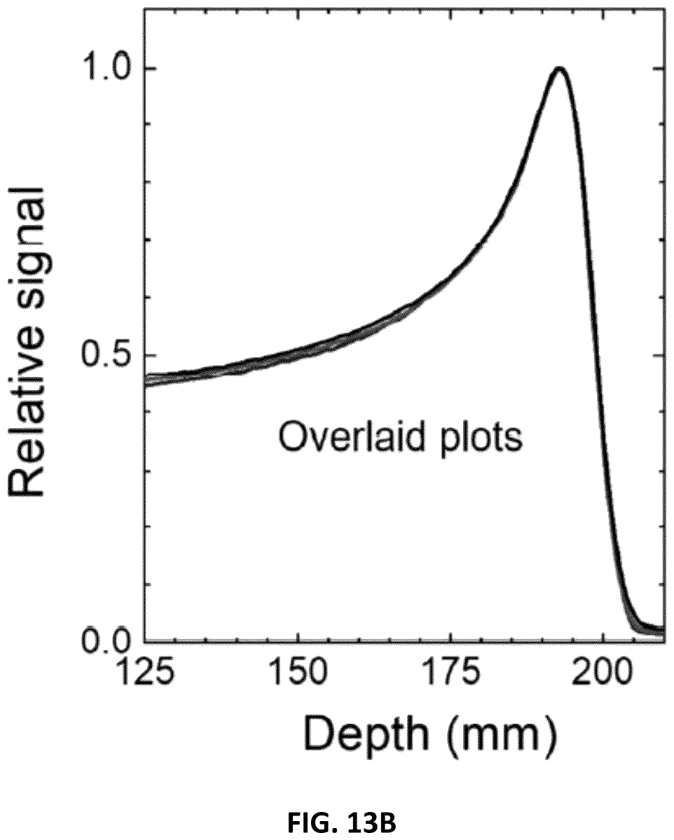

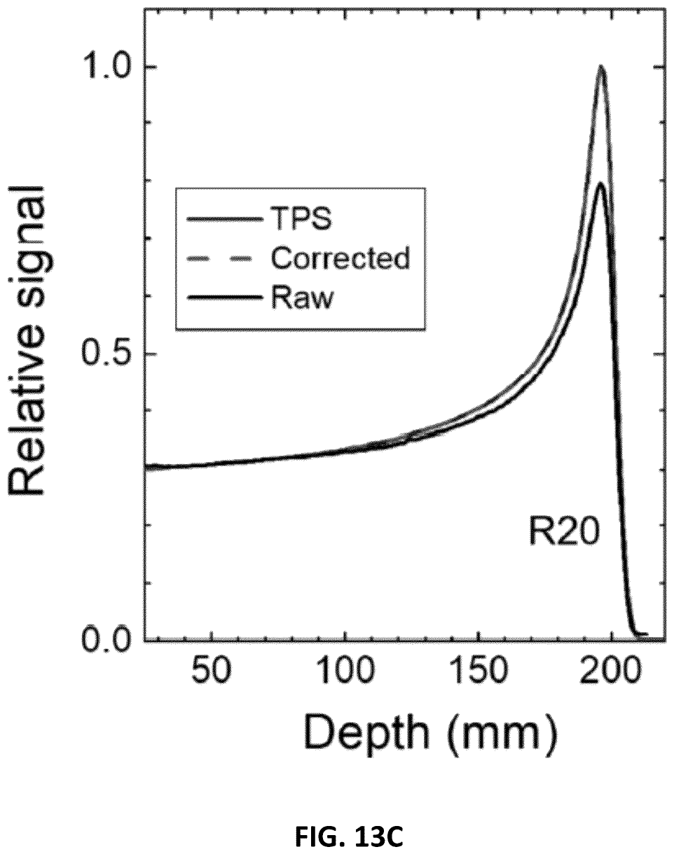

FIG. 13A shows integrated depth intensity profiles for 3 different proton energies (10 cm, 15 cm, and 20 cm) before correcting for ionization quenching. FIG. 13B shows the same 3 profiles shifted and overlaid for their 8 cm most distal part showing that they are similar in shape in terms of the slope of the BP fall off. FIG. 13C shows the same profiles after correction for ionization quenching in comparison with the corresponding IDDs obtained from the treatment planning system (TPS). This heuristic approach works for correcting ionization quenching.

### Range Measurements (S1)

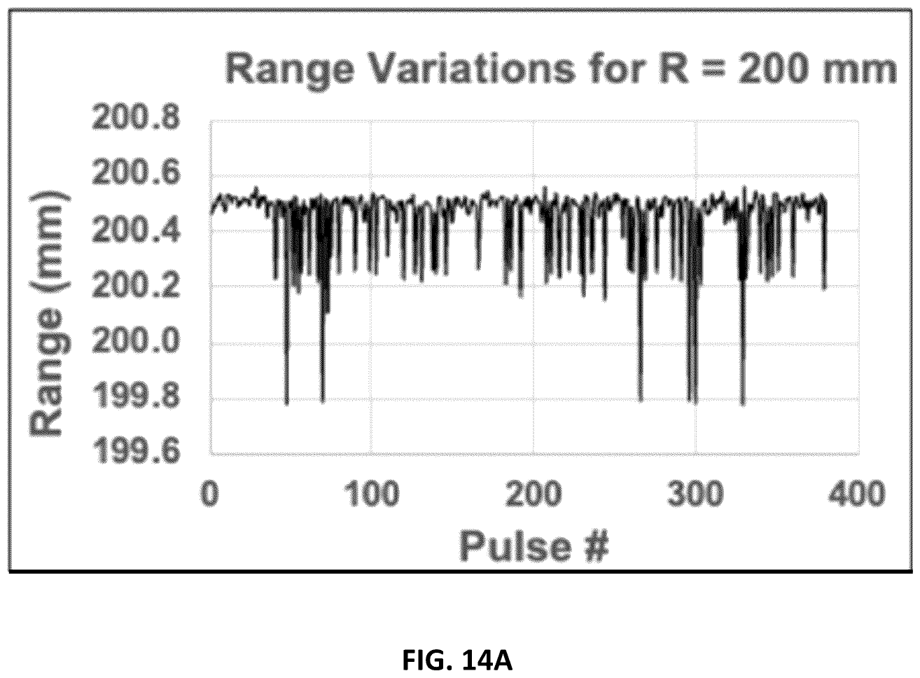

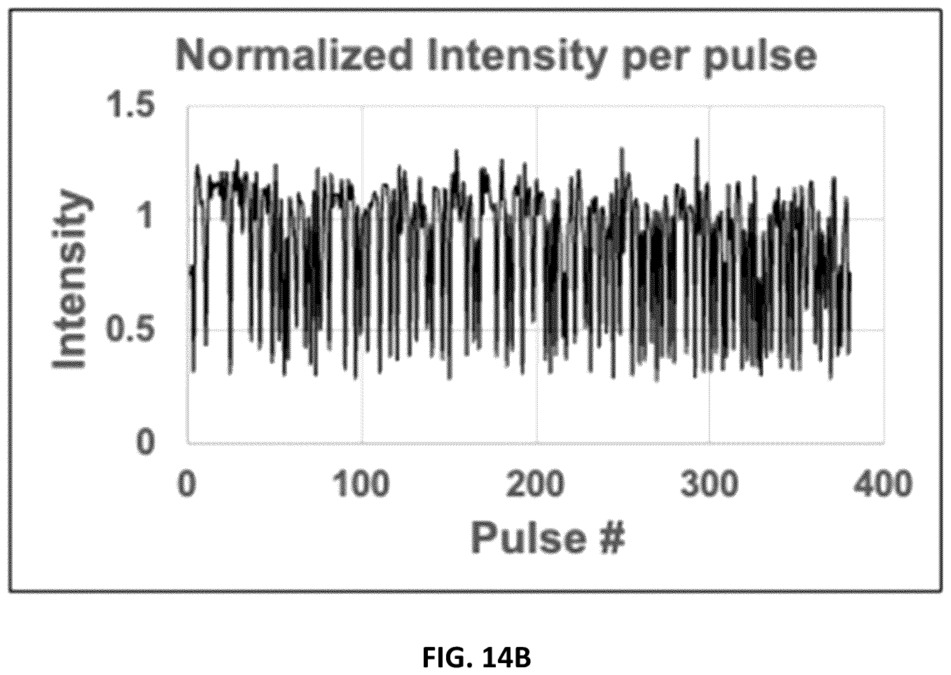

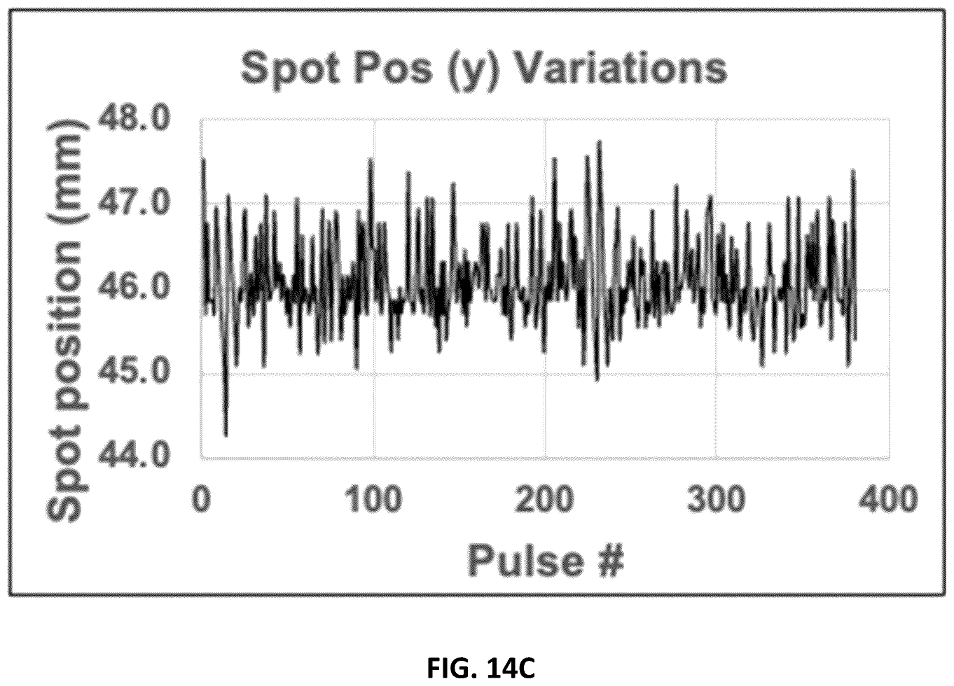

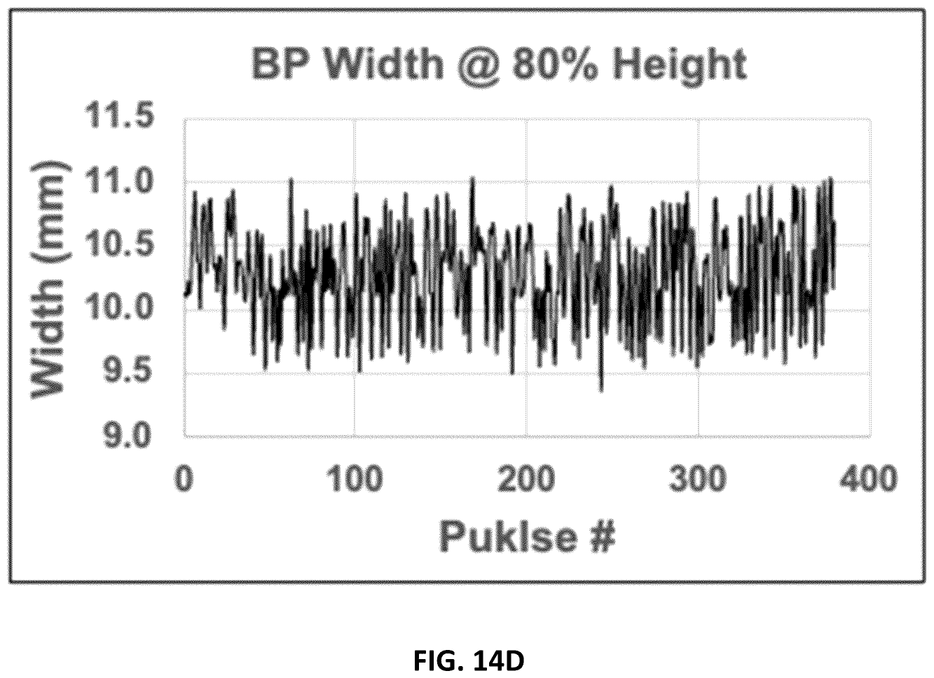

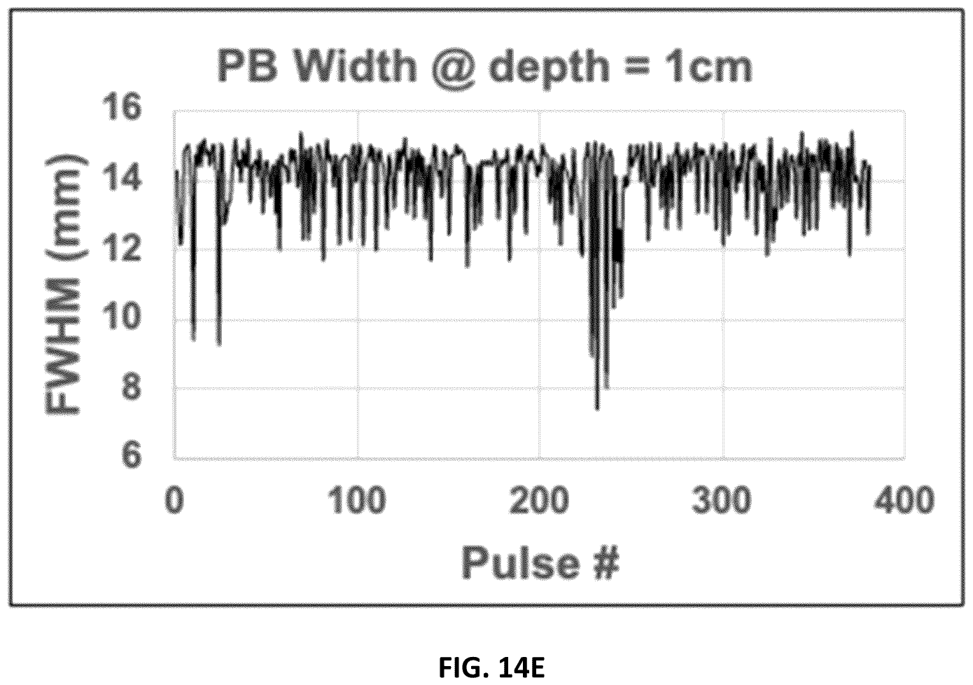

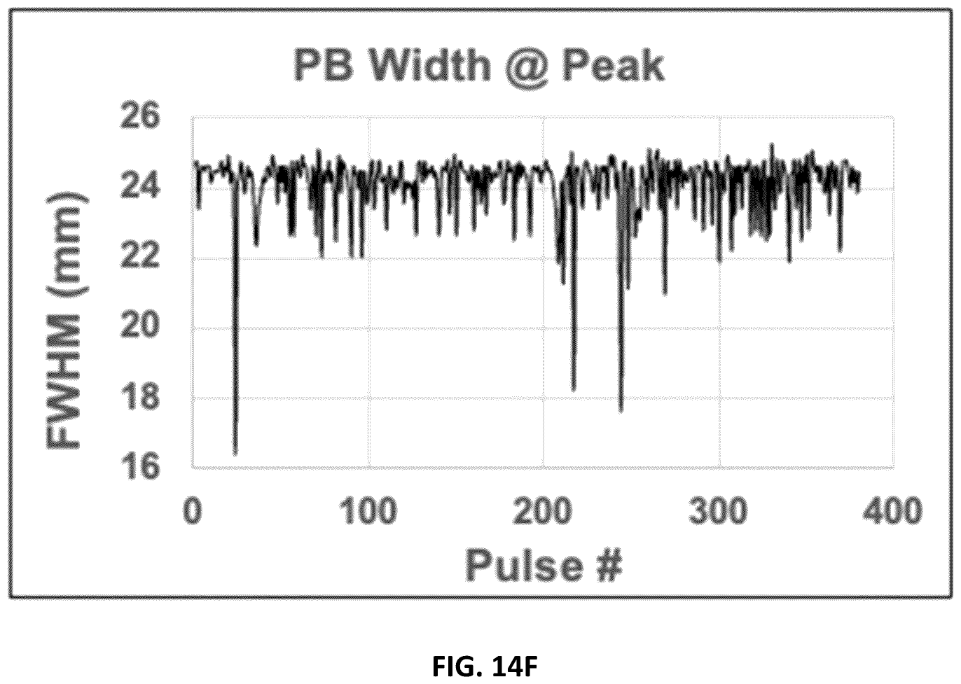

A video demonstrating capturing individual BPs under the first setup (S1) and the offline analysis extracting different beam parameters is provided as a supplementary material (S1). FIG. 14 shows a typical pulse-by-pulse variations of the range measurements (S1) that include proton range, spot intensity, and BP and pencil beam widths measured on pulse-by-pulse through the software script shown in FIG. 10. For example, FIG. 14A shows a typical pulse-by-pulse variations of the range measurements (S1) for 380 proton beam pulses with a 200 mm nominal range. It can be seen very consistent measurement with 0.6 mm variation in range estimation. FIG. 14B shows the relative intensity of individual scintillation images. In physics mode, the charge per pulse is expected to be ˜8 pC which corresponds to ˜5×10⁷ protons per pulse. The beam regulation of the charge per pulse is not very strict and when the monitoring system detects lower charge per pulse it sends a feedback signal so that the machine delivers the so-called “pulse lets” with significantly lower charge per pulse compared to what is expected to compensate for the missing dose. These pulse lets, manifested as scintillation images with weaker intensity compared to the images corresponding to a complete pulse, are responsible for 50% intensity variations in FIG. 14B. FIG. 14C shows the BP position in y-direction (indicated in FIG. 10A) measured for each frame in which the position remains mostly within +1 mm of the average position. The BP width measured at 80% of the peak intensity is shown in FIG. 14D. The pencil beam width measured at 1 cm depth and at the peak intensity is shown in FIGS. 14E and 14F, respectively.

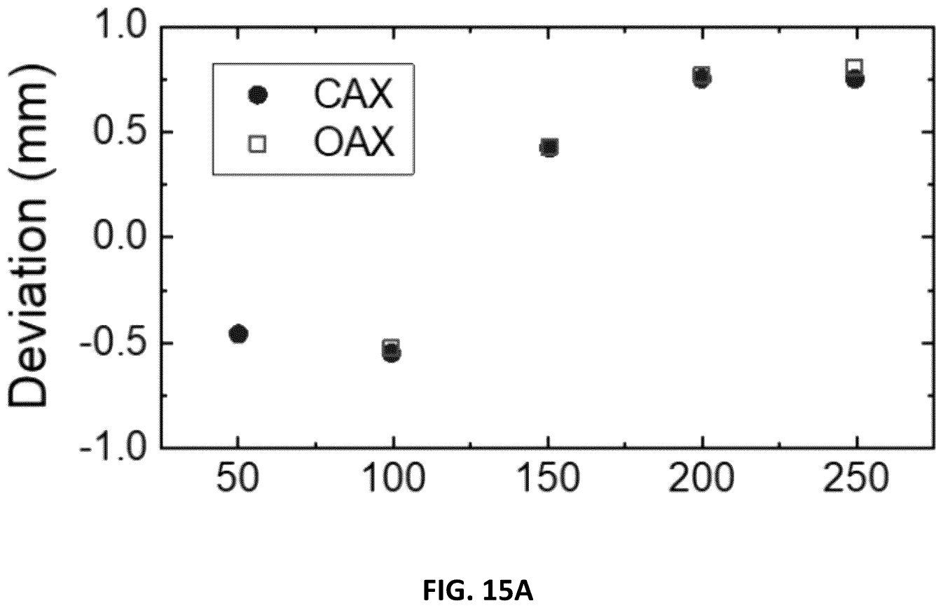

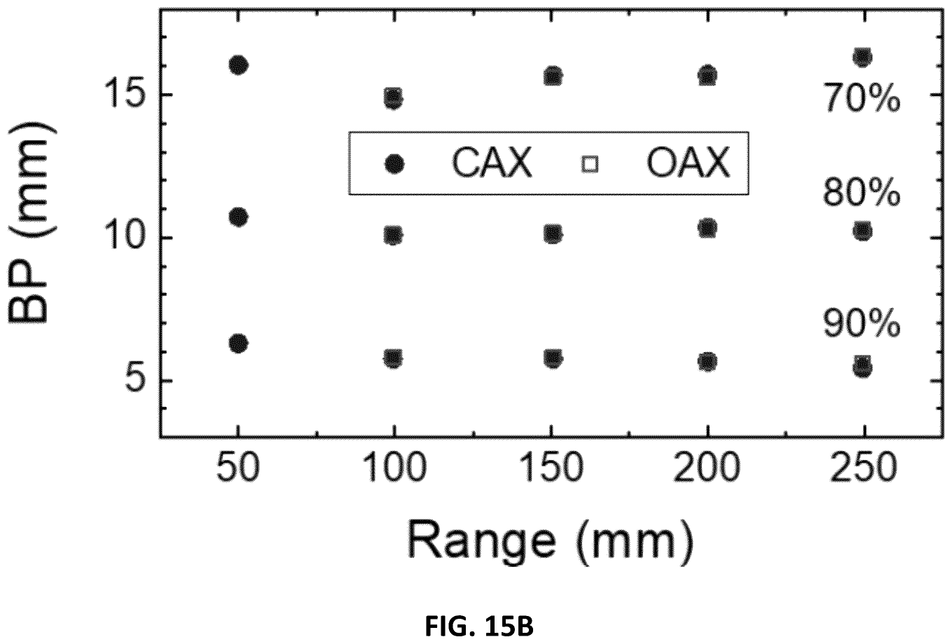

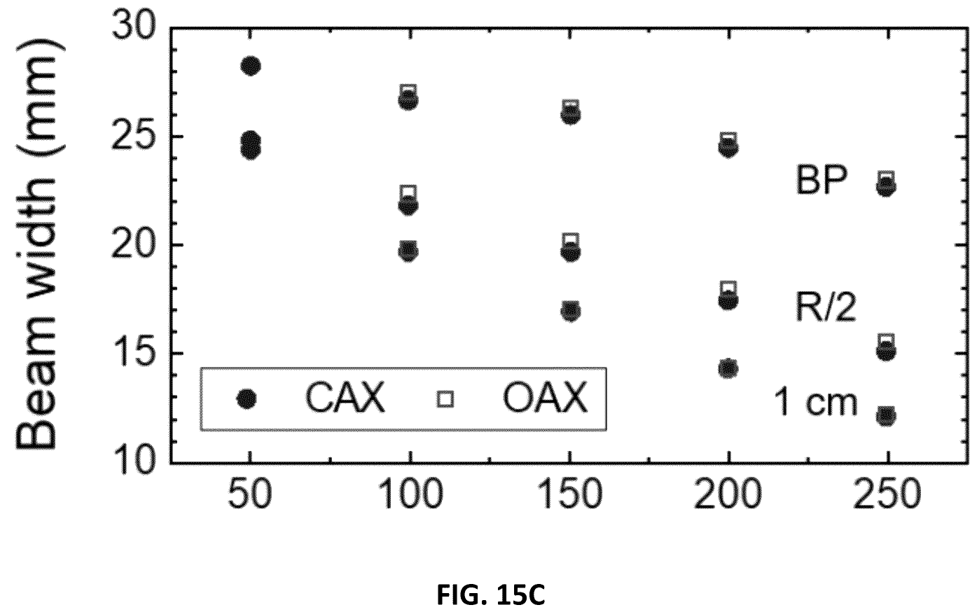

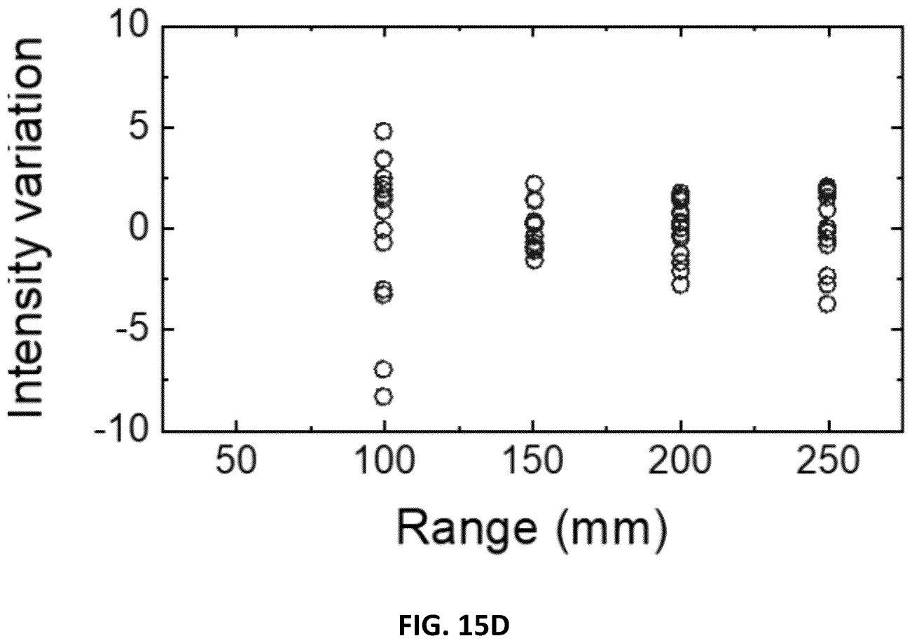

FIG. 15 shows the summary of different proton beam parameters measured through setup 1 (S1). Range uncertainties, BP widths, and pencil beam widths are shown in FIG. 15A-C, respectively. Five different ranges, 5 cm, 10 cm, 15 cm, 20 cm, and 25 cm were measured. For the latter 4 ranges, the results include 4 delivered off-axis (OAX) spots compared against their respective central axis (CAX) spot. The range uncertainty was found to be within +1 mm for all 5 measured ranges and no significant differences were noted between CAX and OAX spots as shown in FIG. 15A. BP widths at 90%, 80% and 70% of its peak height were extracted and presented in FIG. 15B; the flat response is due to the similar slopes of the BPs in the gantry-mounted system. FIG. 15C shows the pencil-beam width at 1 cm depth, mid-range (R/2), and the BP for all 5 delivered proton ranges; no significant differences were noted between the CAX and OAX spot measurements. It can be seen that the beam width increases with depth (and the beam width is larger for beams of shorter range) due to multiple Coulomb scattering. FIG. 15D shows the relative spot intensities of all 15 spots measured for each range. Peak intensities of all 15 spots in each group were averaged over all pulses in order to compute deviations of the individual spot intensities.

### Spot Size and Position Measurements (S2)

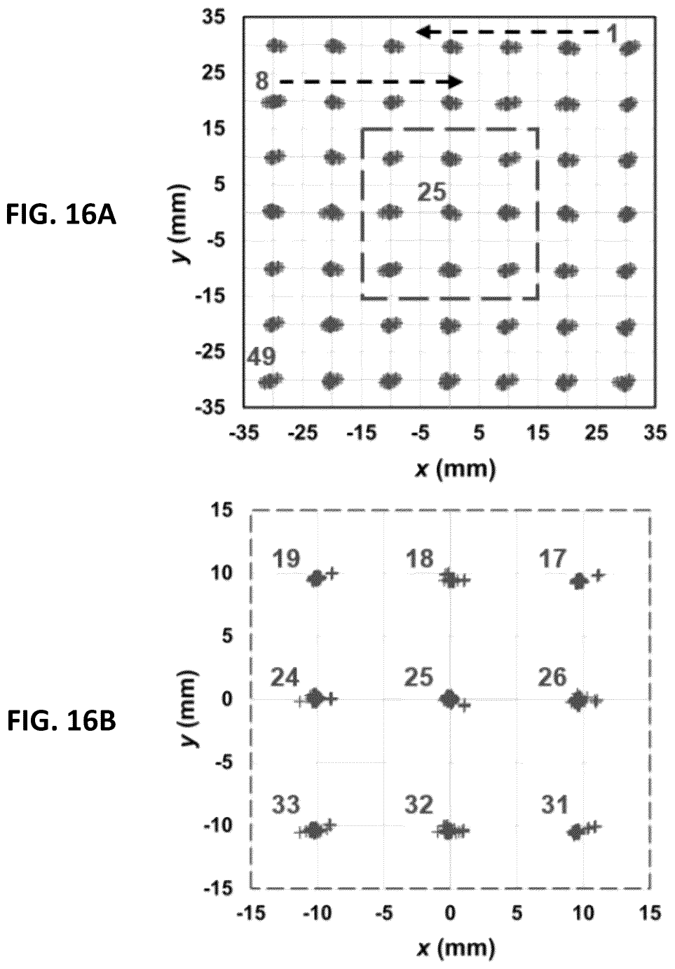

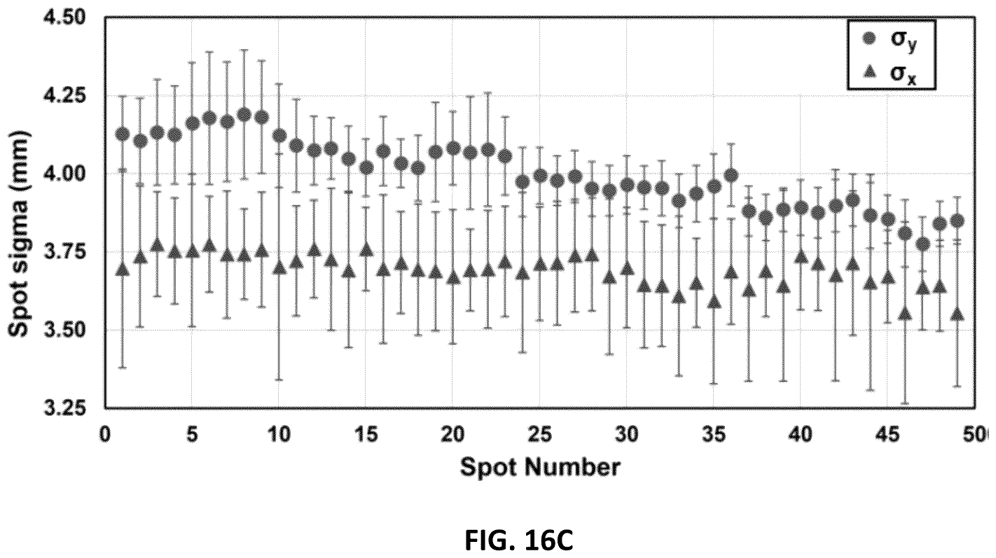

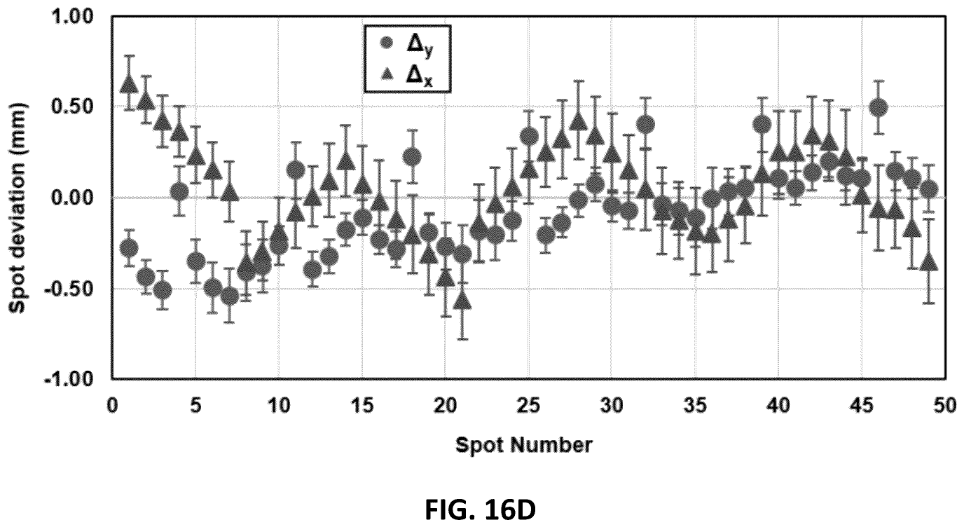

A composite video demonstrating capturing individual spots under the second setup (S2) is provided as a supplementary material (S2). Each spot corresponds to a certain (x,y) coordinate on the image plane. FIG. 16A presents the results of 10,715 pulses of spots with maximum energy proton delivered under the second setup (S2). For presentation, a composite map of the 49 spots positions was obtained from individual frames corresponding to each spot. Nominal spot spacing in x and y directions was 10 mm (radiation field is 6×6 cm²). FIG. 16B is the expanded view of the central 9 spots (2×2 cm²) shown in FIG. 16A. The central spot (#25) corresponds to (x,y)=(0,0), the bottom left spot (#49) is (−30,−30) and the top right spot (#1) is (30,30).

FIG. 16C shows the spot sizes (10) of the 49 spots in x and y direction. The values are 10 of the Gaussian fit of each pulse for each spot. The absolute comparison of the averaged measured spot size against the measurement using Lynx device showed agreement within 0.057 mm in x-direction and 0.159 mm in y-direction. The error bars shown here are the standard deviations. The agreement between the two measurements is on the order of one pixel's width (0.16 mm per pixel).

FIG. 16D shows the deviations in the relative average spot positions (from the average position of the reference spots) in x (spots #24, #25, and #26) and y (spots #18, #25, and #32) direction. It can be seen that the relative positions of the spots are within +1 mm of the average position. The periodic pattern observed in FIG. 16D which is more pronounced for Δx data is believed to be due to a slight misalignment and imperfection of the mirror.

### DISCUSSION

The observed MU linearity indicated the ability of capturing individual delivered pulses and the linearity of the scintillator's emission with respect to the deliver dose. The range measurement through imaging the beam passing the scintillators agreed within +1 mm from the programmed range for beams along the central axis as well as off-axis beams. Previous works through radioluminescence imaging of acrylic blocks and a BC-408 plastic scintillator under proton irradiation indicate similar degree of agreement between the measurements and programmed range. However, the cameras used in previous work had not been synchronized with the accelerator's output while remaining exposed for several minutes. The time-gated camera in this Example (and the Examples herein) enabled one to retrieve different characteristics of proton beams on a pulse-by-pulse basis. The setups used in the abovementioned works could only measure the range not the spot's size nor position in lateral direction with respect to the beam's direction. In some exemplary time-gating embodiments, the shutter speed of each camera matches or is about equal to a pulse frequency of the accelerator. In other exemplary time-gating embodiments, the shutter speed of each camera is about equal to or less than the pulse frequency of the accelerator.

Fukushima et al. reported ˜50% quenching in the response of a BC-400 plastic scintillator under proton irradiation. Robertson et al. reported ˜40-60% quenching in the response of a BC-531 liquid scintillator coupled to an optical fiber under proton irradiation which was corrected by using energy-dependent Monte Carlo-derived correction factors. Previous works had also used energy-dependent Monte Carlo-derived correction factors to correct for the ionization quenching manifested as approximately 60% decrease in the relative response of their BC-408 plastic scintillator. In Example 2, ˜30% quenching was observed, however an empirical method to correct for that was used. The correction method for ionization quenching is not applicable when the proton beams have energy-dependent fall-off slopes as is the case in proton therapy systems equipped with an energy selection system (ESS). In the described compact system, the beam range is changed through the range modulator plates without an ESS which leads to having same slopes of the distal dose fall-off for all beam energies. As such, a common correction factor can be applied to correct the quenching in all energies.

Comparing to previous work with a passive scattering system, by using a camera with larger sensor sizes spatial resolution was improved by an order of magnitude compared to previous work (0.15 mm/pixel vs. 1.33 mm/pixel). By introducing mirrors and a thin scintillation plate, feasibility of spot size and position measurement on a pulse-by-pulse basis with high spatiotemporal resolution has been shown.

The system has potential for comprehensive machine QA of PBS proton beams. Switching between the range (S1) and the spot (S2) measurements' setups is simple; the mirror is expanded for the spot measurement and retrieved for the range measurement which can be done through a motorized apparatus. This will significantly reduce the time compared to making measurements with two different devices. The measurements were performed for clinical proton therapy beams, and the technique has further utility with high spatiotemporal resolution dosimetry of ultra-high 390 dose rate (FLASH) beams. Pulse-by-pulse 3D dosimetry is another extension of the technique described herein, for example by imaging in several directions or by using a plenoptic imaging system. Some embodiments of 3D pulse dosimetry include at least one, two, or three cameras and at least one, two, or three scintillators, and combinations thereof according to the configurations and methods disclosed herein for one to two cameras and one to two scintillators and combinations thereof.

Scintillators are known to show degradation based on their cumulative dose, however, radiation hardness for typical plastic scintillators becomes important as the accumulated dose goes beyond several kGy. Periodic calibration of the plastic scintillators based on their dose history allows one to safely evaluate the quality of the scintillator and once the degradation reaches unacceptable level, the scintillators block can be replaced.

### Conclusions

In Example 2, a scintillation imaging dosimetry system that can image individual proton pulses by synchronizing a camera to a gantry-mounted synchrocyclotron PBS proton therapy system was developed and tested. The camera captured scintillation images with 0.15 mm/pixel resolution corresponding to all beam-pulses. Pulse-by-pulse analysis showed that ranges, spot-positions, and sizes variations were within +0.2% SD of their average values. The absolute ranges were within +1 mm of their expected values. The average spot-positions were within +1 mm and spot-sigma agreed within 0.16 mm of the expected values. In some aspects, the system can be used in ultra-high dose rate (FLASH) dosimetry as well as high spatiotemporal resolution 3D dosimetry.

What is claimed is:

1. A scintillation imaging system for quantifying a dose of a radiation beam, the system comprising:
an accelerator configured to produce a pulsed radiation beam;
an optically sealed enclosure comprising a plastic scintillator detector (PSD) and a high-speed camera; and
a computing device in communication with the high-speed camera;
wherein:
the PSD is configured to receive the pulsed radiation beam and to produce a scintillation signal received directly or indirectly at a shutter of the high-speed camera; and
the shutter is time-gated such that one scintillation image frame is captured for each radiation beam pulse.

2. The system of claim 1, wherein a shutter speed of the high-speed camera is about equal to a pulse frequency of the accelerator.

3. The system of claim 1, wherein the accelerator is selected from a synchrocyclotron and a linear accelerator.

4. The system of claim 1, wherein the pulsed radiation beam is selected from a proton beam, an electron beam, a photon beam, a carbon ion beam, and any other pulsed ionizing radiation beam.

5. The system of claim 1, wherein the high-speed camera is selected from a complimentary metal-oxide semiconductor (CMOS) camera and a charged-coupled device (CCD).

6. The system of claim 1, wherein the computing device comprises a processor configured to execute, for each radiation beam pulse, a computer-implemented algorithm to correct for ionization quenching, to quantify a beam range and to quantify a spot intensity.

7. The system of claim 1, wherein the scintillation signal is received indirectly at the shutter of the high-speed camera via a mirror contained within the optically sealed enclosure such that the mirror reflects the scintillation signal from the PSD to the shutter.

8. A scintillation imaging system for simultaneous quantifying a dose of a radiation beam, the system comprising:
an accelerator configured to produce a pulsed radiation beam;
an optically sealed enclosure comprising a plastic scintillator detector (PSD), a mirror, a first high-speed camera, and a second high-speed camera; and
a computing device in communication with each of the first and second high-speed cameras;
wherein:
the PSD is configured to receive the pulsed radiation beam and to produce a scintillation signal;
a shutter of the first high-speed camera faces the PSD and receives the scintillation signal directly;
a shutter of the second high-speed camera faces the mirror and receives the scintillation signal indirectly as reflected by the mirror; and
wherein each shutter is time-gated such that one scintillation image frame is captured by each camera for each radiation beam pulse.

9. The system of claim 8, wherein the mirror is positioned at a 45 degree angle to the pulsed radiation beam.

10. The system of claim 8, wherein the mirror is retractable.

11. The system of claim 8, wherein a shutter speed of the first and second high-speed camera is about equal to a pulse frequency of the accelerator.

12. The system of claim 8, wherein the accelerator is selected from a synchrocyclotron and a linear accelerator.

13. The system of claim 8, wherein the pulsed radiation beam is selected from a proton beam, an electron beam, a photon beam, a carbon ion beam, and any other pulsed ionizing radiation beam.

14. The system of claim 8, wherein the high-speed camera is selected from a complimentary metal-oxide semiconductor (CMOS) camera and a charged-coupled device (CCD).

15. The system of claim 8, wherein the computing device comprises a processor configured to execute, for each radiation beam pulse, a computer-implemented algorithm to correct for ionization quenching, and to quantify a beam range, a spot intensity, a spot position, and a spot size.

16. A method for quantifying a dose of a radiation beam, the method comprising:
directing a pulsed radiation beam toward a plastic scintillation detector (PSD) contained within an optically sealed enclosure, wherein the optically sealed enclosure further comprises a high-speed camera; and
time-gating a shutter of the high-speed camera to capture one scintillation image frame for each radiation beam pulse directed toward the PSD.

17. The method of claim 16, wherein:
the PSD is a first PSD;
the directing comprises directing the pulsed radiation beam sequentially toward the first PSD and a second PSD contained within the optically sealed enclosure; and
the time-gating comprises time-gating the shutter of the high-speed camera to sequentially capture a first scintillation image frame directly from the first PSD and a second scintillation image frame indirectly from the second PSD as reflected through a mirror contained within the optically sealed enclosure.

18. The method of claim 17, further comprising executing a computer-implemented algorithm to correct for ionization quenching and to quantify beam range, a spot intensity, a spot position, and a spot size for each radiation beam pulse.

19. The method of claim 16, wherein:
the high-speed camera is a first high-speed camera; and
the time-gating comprises time-gating a shutter of the first high-speed camera to capture a first scintillation image frame directly from the PSD and simultaneously time-gating a shutter of a second high-speed camera to capture a second scintillation image indirectly from the PSD as reflected through a mirror contained within the optically sealed enclosure.

20. The method of claim 19, further comprising executing a computer-implemented algorithm to algorithm to correct for ionization quenching and to quantify beam range, a spot intensity, a spot position, and a spot size for each radiation beam pulse.
